(19) United States
(12) Patent Application Publication
(10) Pub. No.: US 2025/0097958 A1
(43) Pub. Date: Mar. 20, 2025

(54) NEW RADIO (NR) SIDELINK RESOURCE ALLOCATION WITH INTER-USER EQUIPMENT (UE) COORDINATION FEEDBACK FILTERING PROCEDURE

(71) Applicant: Intel Corporation, Santa Clara, CA (US)

(72) Inventors: Alexey Khoryaev, Santa Clara, CA (US); Mikhail Shilov, Santa Clara, CA (US); Sergey Panteleev, Kildare (IE)

(21) Appl. No.: 18/723,342

(22) PCT Filed: Feb. 10, 2023
(86) PCT No.: PCT/US2023/062410

§ 371 Date: Jun. 21, 2024

Related U.S. Application Data
(60) Provisional application No. 63/309,853, filed on Feb. 14, 2022.

(51) Int. Cl. H04W 72/25; H04W 72/02; H04W 92/18

(52) U.S. Cl. CPC H04W 72/25; H04W 72/02; H04W 92/18

(57) ABSTRACT

Various embodiments herein provide techniques related to resource selection for sidelink transmissions. In some embodiments, the resource selection procedure may related to identification of whether to use a first or second resource selection procedure. In some embodiments, the resource selection procedure may relate to removal of non-preferred resources from a list of candidate resources. Other embodiments may be described and/or claimed.

### CROSS REFERENCE TO RELATED APPLICATION

The present application claims priority to U.S. Provisional Patent Application No. 63/309,853, which was filed Feb. 14, 2022.

### FIELD

Various embodiments generally may relate to the field of wireless communications. For example, some embodiments may relate to sidelink resource allocation.

### BACKGROUND

Various embodiments generally may relate to the field of wireless communications.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 illustrates an example enhanced resource selection procedure with additional inter-user equipment (UE) coordination (IUC) feedback filtering, in accordance with various embodiments.

FIG. 2 depicts an example of a stop condition with a single threshold, in accordance with various embodiments.

FIG. 3 depicts an example of a stop condition with two thresholds, in accordance with various embodiments.

FIG. 4 illustrates an example relationship between an identified candidate resource set, a non-preferred resource set, and a maximum non-preferred resource set that can be excluded, in accordance with various embodiments.

FIG. 5 illustrates an example of a resource exclusion procedure example with iterative non-preferred resource set exclusion, in accordance with various embodiments.

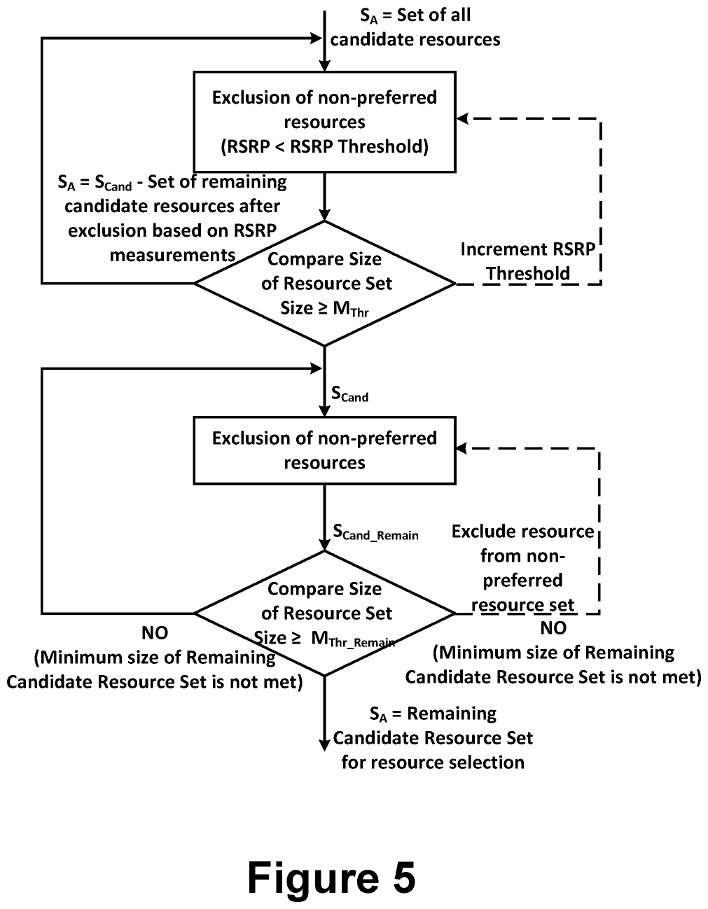

FIG. 6 schematically illustrates a wireless network in accordance with various embodiments.

FIG. 7 schematically illustrates components of a wireless network in accordance with various embodiments.

FIG. 8 is a block diagram illustrating components, according to some example embodiments, able to read instructions from a machine-readable or computer-readable medium (e.g., a non-transitory machine-readable storage medium) and perform any one or more of the methodologies discussed herein.

FIG. 9 illustrates a network in accordance with various embodiments.

FIG. 10 illustrates an example procedure, in accordance with various embodiments.

FIG. 11 illustrates an alternative example procedure, in accordance with various embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A or B” and “A/B” mean (A), (B), or (A and B).

New radio (NR) vehicle-to-anything (V2X) sidelink communication is a synchronous communication system with distributed resource allocation. UEs autonomously select resources for sidelink transmission based on predefined sensing and resource selection procedures implemented by transmit (TX) user equipments (UEs). The sensing and resource selection procedures are designed to reduce potential sidelink conflicts in transmissions or resource reservations (e.g., collisions or half-duplex conflicts). Given that sensing and resource selection procedures may only be executed TX UEs and may not consider the environment at the receiver side, there is non-negligible probability of sidelink conflicts (collisions). To address this problem, the inter-UE coordination feedback from receive (RX) UEs may be used to improve resource allocation decisions by TX UEs and improve overall reliability of NR-V2X sidelink communication.

Inter-UE coordination solutions may be designed for NR V2X sidelink communication. Two example high level inter-UE coordination solutions to improve NR V2X sidelink performance may be as follows (although additional/alternative solutions may be present in other embodiments):
Inter-UE coordination scheme #1 (sidelink conflict/collision avoidance)
   This scheme may utilize inter-UE coordination feedback to avoid half-duplex and collisions problems for NR V2X communication. Generally, a UE providing inter-UE coordination feedback may report preferred and/or non-preferred sets of resources to surrounding sidelink transmitters. Sidelink transmitters may apply TX based sensing procedures and use received inter-UE coordination feedback to select/reserve sidelink resources for transmission and avoid potential sidelink communication conflicts.
Inter-UE coordination scheme #2 (sidelink conflict resolution):
   This scheme may utilize inter-UE coordination feedback to resolve sidelink conflicts that either already occurred or potential future conflicts that were detected based on resource reservation signaling. Generally, sidelink transmitters may be informed about detected sidelink conflicts through inter-UE coordination feedback, so that TX UEs can either perform additional retransmission, or drop planned transmission and reselect resource for transmission or continue transmission on reserved resource.

The above example schemes, however, may not address one or more of the following questions or issues:
How to select resource for transmission when inter-UE coordination (IUC) information is received
How to consider feedback from multiple UEs
How to overcome issue with over-exclusion of non-preferred resources
What is the relationship between cast type of IUC feedback and cast type of transmission for which resources are determined by TX UEs and feedback from which UEs should be considered?
Details of the non-preferred resource set formation

Various embodiments herein may relate to one or more of the above questions or issues. Generally, legacy solutions for sidelink communication may only consider TX based sensing procedures to select resource for transmission, and may not utilize feedback from receivers. As such, the legacy solutions may not have a sufficient level of information on resource utilization, and thus may have a lower level of achievable reliability for sidelink communication than the level of reliability that may be presented by embodiments herein.

More specifically, embodiments herein may relate to one or more of the following:
Configuration of the type of the used resource selection procedure
Definition of the relationship between thresholds used to generate preferred and non-preferred resource sets
Conditions to determine whether half-duplex issue at time resource is expected/exist
Enhanced IUC feedback filtering procedure that takes into account cast type of the transmission, cast type of the feedbacks, feedback source identifiers, transmission destination identifiers.
Enhanced resource selection stop condition that takes into account both the number of candidate resources selected based on own sensing results only and number of candidate resources after non-preferred resources exclusion
Enhanced non-preferred resource exclusion procedure with the following potential enhancements:
   Dynamically disable of the non-preferred resource exclusion
   Take into account partial number of non-preferred resources to satisfy resource exclusion stop conditions

Aspects of various embodiments herein may increase reliability of NR sidelink communication.

### NR Release-17 UEs Sidelink Resource Selection Procedure Configuration

In NR Release-17 some enhancements to the resource selection procedure targeting power saving and reliability improvements may be introduced. Legacy specifications may not define whether a Release-17 UE should follow NR Release-17 or Release-16 resource selection procedures. From the system level perspective, it may be desirable to include a mechanism that requests all capable Release 17 UEs to follow Release 16 or Release 17 resource allocation procedures if those are enabled per resource pool.

In one embodiment pre-configuration may request capable Release 17 UEs to follow procedures for generation/transmission and application of inter-UE coordination feedback for various sidelink transmission types. The following is a non-exclusive list of sidelink transmission types that may be subject to such procedures, although it will be recognized that, in some embodiments, one or more of the following may additionally or alternatively follow a different procedure:
Sidelink transmissions without IUC feedback or request for IUC feedback
Sidelink transmissions which include IUC feedback
Sidelink transmissions which include request for IUC feedback
Sidelink transmissions which contain only IUC feedback
Sidelink transmissions which contain only request for IUC feedback
Sidelink transmissions with resource selection based on partial sensing
Sidelink transmissions with resource selection based on full sensing
Sidelink transmissions with random resource selection procedures
Etc.

Pre-configuration may be provided per sidelink transmission type or a subset of sidelink transmission types. If pre-configuration is not provided, then decision on whether to use Release-16 procedure (without considering IUC feedback information) or Release-17 (with considering IUC information) can be left up to UE implementation. If pre-configuration is provided Release-17 UEs are expected to follow procedures for generation, transmission, and application of IUC feedback for resource selection. Otherwise the decision on which procedure to use may be left up to implementation of Rel-17 UE subject to their capability.

### Assisting UE (UE-A) Inter-UE Coordination Information Generation and Reporting Example Details

### Example Details of the Configuration of the Preferred/Non-Preferred Resource Sets Generation

In some embodiments, each UE may independently decide which type of resource set (preferred or non-preferred) will be reported as a content of inter-UE coordination (IUC) information. A data transmitting UE (UE-B) may receive and process IUC feedbacks from multiple UEs, the IUC feedbacks may include resources generated in consistent manner, e.g., resource with the same reference signal received power (RSRP) level should not be included in both resource sets (preferred and non-preferred). To ensure this behavior, the RSRP thresholds used to classify resources as preferred and non-preferred should be consistently configured.

In embodiments, preferred and non-preferred resource sets may be generated as follows:

### Condition 1-A-1 (Preferred Resource Set)

Resource(s) excluding those overlapping with reserved resource(s) of other UE identified by UE-A whose RSRP measurement is larger than a RSRP threshold

### Condition 1-B-1 (Non-Preferred Resource Set)

Option 1: Reserved resource(s) of other UE(s) identified by UE-A whose RSRP measurement is larger than a (pre) configured RSRP threshold which is determined by at least priority value indicated by sidelink control information (SCI) of the UE(s)
Option 2: Reserved resource(s) of other UE identified by UE-A whose RSRP measurement is smaller than a (pre) configured RSRP threshold which is determined by at least priority value indicated by SCI of the UE(s) when UE-A is a destination of a transport block (TB) transmitted by the UE(s)

To prevent inclusion of the same resource with the same level of sidelink RSRP measurement in both preferred and non-preferred resource sets, the following relationship between RSRP thresholds may be desired:
ThrRSRPpreferred≤ThrRSRPmax,preferred≤ThrRSRPnon-preferred (Option 1)
ThrRSRPnon-preferred (Option 2)≤ThrRSRPpreferred

To support these relationships between thresholds, the pre-configuration of the maximum value of RSRP threshold for generation of preferred resource set may be determined to ensure that the above conditions can be controlled by proper configuration of sidelink RSRP thresholds

If one or more of the above conditions cannot be guaranteed at system level by pre-configuration settings (e.g., RSRP threshold configuration) the UE behavior may be defined based on whether resources that belong to both preferred and non-preferred resource sets are considered as preferred or non-preferred.

If a candidate resource is contained in both preferred and non-preferred resource sets (that are received from the same UE-A) then a TX UE can treat such a resource as a preferred resource only if pre-configuration signaling is provided. Otherwise, the UE may treat the resource as non-preferred (e.g., non-preferred may be the default unless otherwise indicated).

### Non-Preferred Resource Set Generation Procedure Details

Non-preferred resource set reported in IUC feedback may include resources that satisfy at least one of the following conditions:
In scheme 1, at least the following is supported to determine inter-UE coordination information of non-preferred resource set:
   UE-A considers any resource(s) satisfying at least one of the following condition(s) as set of resource(s) non-preferred for UE-B's transmission
      Condition 1-B-1:
         Reserved resource(s) of other UE identified by UE-A from other UEs' SCI (including priority field) and RSRP measurement
         FFS: Other details (if any)+
      FFS: Condition 1-B-2:
         Resource(s) (e.g., slot(s)) where UE-A, when it is intended receiver of UE-B, does not expect to perform SL reception from UE-B
         FFS: Other details (if any)
For Scheme 1 with non-preferred resource set, support following condition:
   Condition 1-B-2:
      Resource(s) (e.g., slot(s)) where UE-A, when it is intended receiver of UE-B, does not expect to perform SL reception from UE-B due to half duplex operation

For condition 1-B-2, the details of the procedure used to identify resources under half-duplex operation may be subject to one or more of the following considerations:
Non-preferred resources based on Condition 1-B-2 can be determined based on TX/RX prioritization procedure for sidelink and may include one or more of the following resource types:
   Slots with reserved resources where half-duplex conflict (simultaneous transmission and reception) was detected by UE-A based on priority rules for sidelink reception and UE-A transmission (sidelink or uplink) resulting in half-duplex conflict for reception
   Slots with reserved resources for transmission and potential half-duplex conflict (e.g., half-duplex conflict is not detected yet by UE-A but may happen due to future reservations made by TX-UEs).

One or more of the following resources may or may not be considered as non-preferred resources that can be predefined by specification or left up to pre-configuration:
If UE-A is aware that reserved resource for transmission will not be used for actual transmission (e.g., due to ACK feedback or other reason) the reserved resource should not be indicated as non-preferred resource
Slots with preselected but not reserved resources where half-duplex conflict was detected by UE-A based on priority rules for sidelink reception and UE-A transmission (sidelink or uplink) resulting in half-duplex conflict for reception
Slots with preselected but not reserved resources for transmission and potential half-duplex conflict (e.g., half-duplex conflict is not detected yet by UE-A but may happen due to future reservations made by TX-UEs)

### Details of TX UE Behavior (UE-B-Transmitter Selecting Resources)

Feedback Source and Cast Type in Application to Resource Selection for Sidelink Transmission with Various Cast Types/Destinations

Cellular networks may support sidelink communication with one or more of the following three cast types-broadcast, groupcast and unicast. The same cast types may also be used for IUC feedback transmission. One of the open aspects is how TX UE should process feedback of the specific cast types and consider it for resource selection.

Below are some example details of the TX UE behavior for IUC feedback processing for various cast types of sidelink transmissions. Specifically, the below relates to the relationship of feedback cast type and its application to resource selection for sidelink transmission of certain cast type by UE-B.

The RSRP conditions 1-A-1 and 1-B-1 may be applied for generation of the preferred and non-preferred resource set(s) respectively. These conditions may be transparent to cast types and therefore, irrespectively of feedback cast type can be considered for resource selection targeting sidelink transmission of any cast type.

The half-duplex conditions 1-A-2 and 1-B-2 may be dependent on UE-A resource reservations/potential transmissions. Condition 1-A-2 may be disabled. If it is enabled, UE-A removes from RSRP based preferred resource set resources corresponding to slots where UE-A has made reservations. This is in general beneficial or at least not harmful for resource allocation procedure as preferred resource set is not directly excluded from candidate resources determined by TX-UE.

Condition 1-B-2 may not be disabled (e.g., there is no agreed pre-configuration to enable/disable it) and is used to identify non-preferred half-duplex resources. Resources reserved for transmission by UE-A (non-preferred half-duplex resources), do not need to be directly excluded by UE-B if UE-A is not a target recipient of UE-B transmission. It means that whether to exclude non-preferred resources associated with condition 1-B-2 depends on whether UE-A is target RX in considered sidelink transmission.

Embodiments herein relate to one or more of the following design principles to incorporate inter-UE coordination feedback into TX resource selection procedure:
Design Principle #1: Content of request and/or condition-based inter-UE coordination information is transparent to cast type of sidelink transmission carrying inter-UE coordination feedback (Procedure for feedback generation is not aware about cast type of sidelink transmission carrying feedback)
Design Principle #2: Procedure for filtering inter-UE coordination information is defined to determine which of the received feedback and its content can be used to form preferred and non-preferred resource sets for resource selection
Design Principle #3: Resource selection procedure is transparent to (1) cast type of inter-UE coordination information and (2) cast type and destination UE(s) of sidelink transmission
Design Principle #4: Non-preferred resources corresponding to Condition 1-B-2 are filtered out by TX-UE in case of (1) broadcast sidelink transmissions or (2) when UE-A is not target receiver
Design Principle #5: Inter-UE coordination information (e.g., resources associated with conditions 1-A-1 & 1-A-2, 1-B-1) from both target and non-target receivers can be used to form preferred and non-preferred resource set for resource selection procedure (including resource exclusion and re-evaluation)

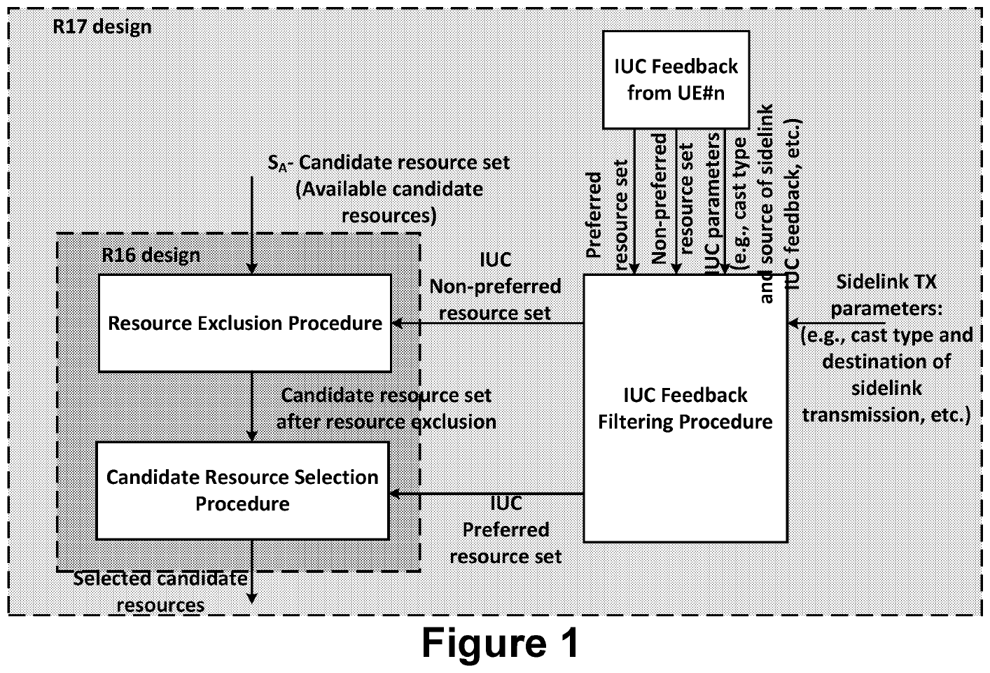

The example design of FIG. 1 may be used in some embodiments to implement one or more of the above-described design principles.

To make resource selection procedure transparent to the details of IUC feedback, the IUC feedback filtering procedure described herein may be used. This procedure may use parameters of IUC feedback and parameters used for sidelink transmissions in order to form preferred and non-preferred resource set for further resource exclusion and resource selection procedure.

The IUC feedback filtering procedure may use one or more of the following example IUC feedback parameters to process IUC feedback from multiple UEs and generate preferred and non-preferred resource sets for resource selection. However, it will be noted that other embodiments may use additional or alternative parameters, or not use one or more of the below parameters. The parameters may be as follows:
Cast type of IUC information/feedback
Source (e.g., source ID) of IUC information/feedback
Feedback generation timestamp (e.g., start/end slot of resource selection or sensing window, reference slot)
Number of subchannels per resource
Resource selection window for feedback generation
Priority used for IUC feedback generation
Resource set type (preferred or non-preferred)
IUC feedback type (request based or condition based)
Resource sets (preferred, non-preferred resources)
Reservation period for feedback generation

The IUC feedback filtering procedure may also use one or more of the following parameters of UE-B sidelink transmission to form preferred and non-preferred resource sets.

However, as above, other embodiments may use more, fewer, or different parameters in other embodiments:
Cast type of sidelink transmission
Destination (e.g., destination ID) of sidelink transmission
Number of subchannels per sidelink resource for transmission
Resource selection window for sidelink transmission (e.g., start/end slot of RSW)
Priority used of sidelink transmission
Reservation period for sidelink transmission

One or more of the above parameters may be used to filter out feedback from multiple UEs and determine ICU feedbacks that can be used for generation of preferred and non-preferred resource sets for sidelink transmission.

### Use of Priority Information for Feedback Filtering

Feedback may be applied if priority used for feedback generation and priority used for sidelink transmission satisfy one or more of the following example predefined or pre-configured criteria/conditions (although other embodiments may have different criteria):
Alt. 1: Priority value used for feedback generation≤priority value of transmission.
Alt. 2: Priority value used for feedback generation==priority value of transmission
Alt. 3: Priority value used for feedback generation≥priority value of transmission

### Use of Reservation Period Information for Feedback Filtering

Feedback may be applied if reservation period for feedback generation and reservation period for sidelink transmission satisfy one or more of the following example predefined or pre-configured criteria/conditions (although other embodiments may have different criteria):
Alt. 1: Reservation period used feedback generation==reservation period of transmission.
Alt. 2: Reservation period used feedback generation is multiple of reservation period of transmission
Alt. 3: Reservation period transmission is multiple of reservation period used for feedback generation

### Use of Resource Selection Window for Feedback Generation and Resource Selection Window for Transmission

May be is applied if the resource selection window (RSW) for feedback generation and RSW for sidelink transmission satisfy one or more of the following example predefined or pre-configured criteria/condition (although other embodiments may have different criteria):
Alt. 1: RSW for feedback is within RSW for transmission
Alt. 2: RSW for transmission is within RSW for feedback
Alt. 3: RSWs overlap on certain amount of slots

### Use of Feedback Generation Timestamps

Feedback may be applied if feedback generation timestamp/reference slot (e.g., start slot of RSW) satisfies one or more of the following example predefined or pre-configured criteria/conditions (although other embodiments may have different criteria):
Alt. 1: Current slot-Feedback timestamp (reference slot)<pre-configured or predefined value
Alt. 2: Start (or end) slot of RSW for transmission-Feedback timestamp (reference slot)<pre-configured or predefined value
Alt. 3: Slot associated with trigger for sidelink resource selection-Feedback timestamp (reference slot)<pre-configured value

### Utilization of Cast Types and Source/Destinations in Feedback Filtering Procedure

In this section, embodiments may relate to how cast type+source of sidelink information/feedback and cast type+destination of sidelink transmission may be used to determine whether feedback is applicable to form preferred or non-preferred resource set. In one embodiment, this information may be used to support the following alternatives for feedback filtering that can be preconfigured or predefined by specification:

Alternative 1: (Cast Type+Source of Feedback is Matched with Cast Type+Destination of Sidelink Transmission)
To apply unicast IUC feedback for unicast sidelink transmission
   Filtering procedure determines whether the source of unicast IUC feedback is a destination of sidelink unicast transmission
To apply groupcast IUC feedback for groupcast sidelink transmission
   Filtering procedure determines whether the source of feedback is a group member of sidelink groupcast transmission
   Filtering procedure determines whether the source of feedback is a destination of sidelink groupcast transmission
To apply broadcast IUC feedback for broadcast sidelink transmission
   Filtering procedure determines whether the source of broadcast IUC feedback is destination/target RX of sidelink broadcast transmission

### Alternative 2: (Source of Feedback is Destination of Sidelink Transmission)

To apply IUC feedback for sidelink transmission
   Filtering procedure determines whether the source of IUC feedback is destination/target RX of sidelink transmission. In this case, the following combinations can be enabled:
      Unicast transmission to UE-n/Broadcast feedback from UE-n
      Groupcast transmission to group-n UE(s)/Broadcast feedback from group-n UE(s) (same group of UEs)
      Broadcast transmission/Broadcast inter-UE coordination information (feedback)
      Unicast transmission to UE-n/Groupcast feedback from UE-n (same UE).
         Note: Groupcast feedback from UE-m (different group of TX UE) is not received by UE-n
      Groupcast transmission to group-n UE(s)/Groupcast feedback group-n UE(s) (same group as TX UE)
      Broadcast transmission/Groupcast feedback from group member(s)
      Unicast transmission to UE-n/Unicast feedback from UE-n
      Groupcast transmission to group-n UEs/Unicast feedback from group-n UE(s)
      Broadcast transmission/Unicast feedback from UE(s)

### Alternative 3 (Destination of Feedback is Source of Sidelink Transmission)

To apply IUC feedback for sidelink transmission
   Filtering procedure determines whether the destination of IUC feedback is source of sidelink transmission. In this case the following combinations can be enabled:
      Unicast transmission/Broadcast feedback
      Groupcast transmission/Broadcast feedback
      Broadcast transmission/Broadcast feedback
      Unicast transmission/Groupcast feedback from group member(s)
      Groupcast transmission/Groupcast feedback from group member(s)
      Broadcast transmission/Groupcast feedback from group member(s)
      Unicast transmission/Unicast feedback to TX UE
      Groupcast transmission/Unicast feedback to TX UE
      Broadcast transmission/Unicast feedback to TX UE

### Control of Non-Preferred Resources Exclusion

In some cellular networks:
For Scheme 1 with non-preferred resource set, the physical layer at UE-B may exclude in its resource (re-)selection, candidate single-slot resource(s) obtained after Step 6) of the third generation partnership project (3GPP) release-16 (Rel-16) technical specification (TS) 38.214 Section 8.1.4 overlapping with the non-preferred resource set.

In these situations, the exclusion of non-preferred resource set is performed before checking remaining amount of candidate resources for selection (e.g., comparing the size of candidate resource set with X % Mₜₒₜₐₗ, where X is preconfigured and Mₜₒₜₐₗ is determined from resource selection window and parameters of transmission: e.g., number of sub-channels for transmission, priority, etc.). According to the legacy resource exclusion procedure, condition on X % of candidate resources is expected to be satisfied. However, one or more of the following issues may arise:
1) The minimum amount of candidate resources may not be satisfied due to exclusion of non-preferred resources
2) The increment of RSRP threshold to achieve X % of candidate resources after non-preferred resource exclusion may result in selection of resources with high RX power, e.g., higher interference/congestion

To mitigate the above issues, enhancements to control procedure of non-preferred resource exclusion may be desirable.

Some potential solutions may be categorized in the following two example types:
Type 1 (Full/hard exclusion of non-preferred resources): Solutions where full set of non-preferred resources is excluded.
Type 2 (Partial/soft exclusion of non-preferred resources): Solutions where subset of non-preferred resources may be excluded

Both of the above example solution types may assume internal iteration loop to achieve minimum required size of candidate resource set for resource selection procedure. RSRP threshold may be incremented each iteration to satisfy threshold on size of the candidate resource set for resource selection.

For solutions of both types, the successful exit from iteration (stop condition) may be controlled by one or two thresholds. The following example alternatives of the condition definitions may be possible (although other alternatives may be present in other embodiments):
Alternative 1 (Single threshold on size of candidate resource set for resource selection);

For each RSRP threshold, the set of candidate resources S_{Cand} is identified based on TX UE sensing. After that, the full set or subset of non-preferred resources S_{NP} may be excluded from the identified candidate resource set S_{Cand} and the set of remaining candidate resources S_{Cand} Remain is obtained.

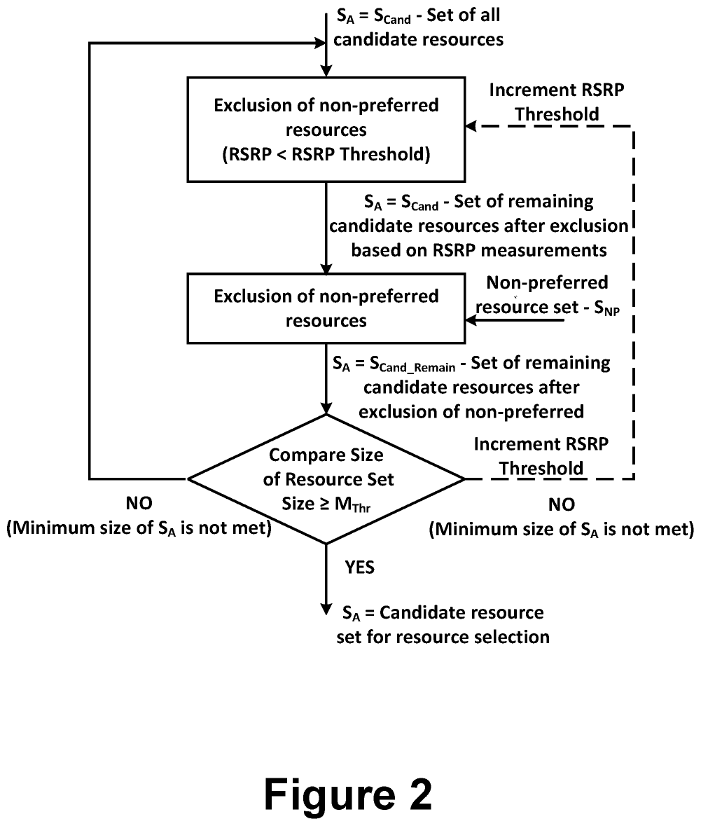

The size of the remaining candidate resource set S_{Cand_Remain} may be compared with preconfigured threshold M_{Thr} (e.g., M_{Thr}=X % Mₜₒₜₐₗ). The procedure may be considered as successfully completed, if size (S_{Cand} Remain)≥M_{Thr}. Otherwise, RSRP threshold may be increased and the procedure may be repeated. FIG. 2 depicts an example of this procedure, although it will be recognized that in other embodiments the procedure described herein and illustrated with respect to FIG. 2 may include more/fewer/different elements than are depicted.
Alternative 2 (Two thresholds on size of candidate resource sets):

For each RSRP threshold, the set of candidate resources S_{Cand} may be identified based on UE own sensing information. After that, the full set or subset of non-preferred resources S_{NP} may be excluded from the identified candidate resource set S_{Cand} and the set of remain candidate resources S_{Cand_Remain} is obtained. The size of the remaining candidate resource set S_{Cand_Remain} is compared with preconfigured separate threshold M_{Thr_Remain} and the size of the candidate resource set S_{Cand} is compared with preconfigured threshold M_{Thr}. The procedure may be considered as successfully completed if the following conditions are simultaneously satisfied:
size (S_{Cand_Remain})≥M_{Thr_Remain}
size (S_{Cand})≥M_{Thr}

Otherwise, the RSRP threshold may be incremented, and the procedure may be repeated for the incremented threshold.

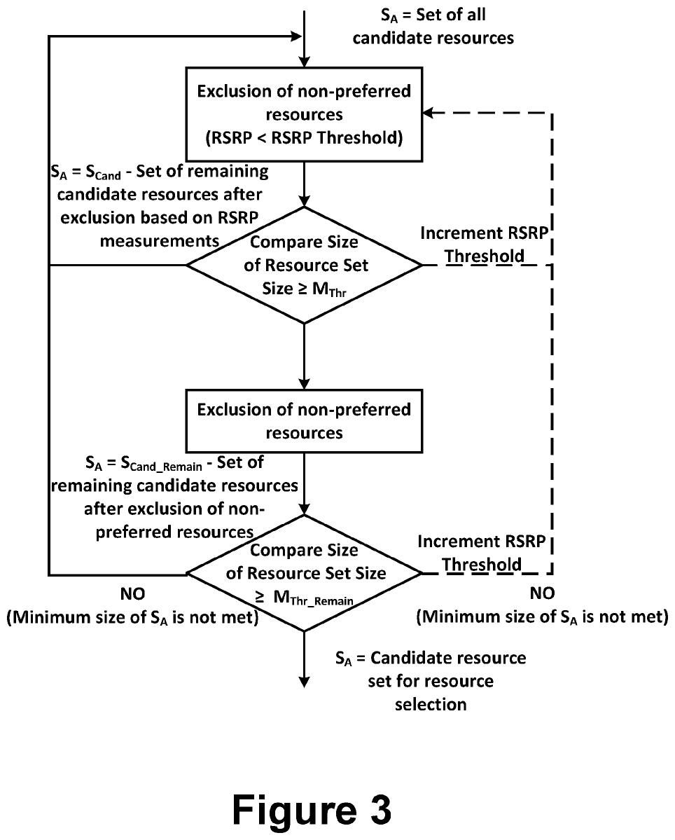

Additional threshold M_{Thr_Remain} may be defined as a portion of total number of resources or as a portion of a maximum number of remaining resources. FIG. 3 depicts an example of this procedure, although it will be recognized that in other embodiments the procedure described herein and illustrated with respect to FIG. 3 may include more/fewer/different elements than are depicted.

Solutions of Type 1: Solutions with Full/Hard Exclusion of Non-Preferred Resources

It is assumed that full set of provided non-preferred resources (S_{NP}) is excluded in resource exclusion procedure.

In this case, it is possible that stop criteria to exit iteration loop may not be met even if the maximum RSRP value is configured and reached. As a results the size of the candidate resource set for selection may be too small.

In this case, one or more of the following example options may overcome this issue (although, in other embodiments, additional or alternative options may be used):
Option 1: Report to higher layers the set of candidate resources S_{cand} obtained based on UE own sensing information at the iteration over RSRP, where size (S_{Cand}) becomes equal or greater than M_{Thr}
Option 2: Report to higher layers the remaining set of candidate resources S_{Cand_Remain} obtained at the last iteration over RSRP.
Option 3: Report to higher layers the full set of resources obtained after step 5a), e.g., all candidate resources (please refer to TS 38.214 section 8.1.4)
Option 4: Report to higher layers the set of candidate resources obtained using resource exclusion procedure where before resource exclusion procedure evaluated the condition whether completion criteria can be satisfied if non-preferred resource exclusion procedure is enabled and triggered.

If it is decided that a non-preferred resource exclusion procedure is enabled, the non-preferred resource set exclusion may be triggered, otherwise resource the selection procedure may be executed without non-preferred resource set exclusion.

To evaluate whether non-preferred resource exclusion is triggered or not, the minimum number of resources in remaining candidate resource set after non-preferred resource set exclusion can be estimated and compared with the threshold. This evaluation can be performed before the start of iterative resource exclusion process (e.g. element 6-element 7) and after element 5a (please refer to TS 38.214 section 8.1.4)

To estimate the minimum number of resources in remaining candidate resource set, the non-preferred resource set S_{NP} is excluded from the set SA obtained after element 5a and the number of remaining resources is counted.

If the number of counted remaining resources exceeds threshold value, the non-preferred resource set exclusion is triggered, otherwise resource selection procedure is executed without non-preferred resource set exclusion.

As a threshold value used for evaluation, M_{Thr} value is used if non-preferred resource exclusion is disabled (e.g. stop condition criteria alternative 1 is used) and two-threshold condition with M_{Thr} and M_{Thr_Remain} is used if non-preferred resource exclusion is enabled (e.g. alternative 2 stop criteria is used).

Solutions of Type 2: Solutions with Partial/Soft Exclusion of Non-Preferred Resources

Another group of design options includes the solutions where the only subset of non-preferred resource set (up to maximum resource set size) is excluded from candidate resource set.

To identify subset(s) of non-preferred resources considered in iterative resource selection, the number of resources in a used subset of non-preferred resources may be estimated. Such estimation may be performed based on one or more of the following example design options (although, other embodiments may additionally/alternatively use one or more different design options):
Option 0: Restrict the maximum size of the non-preferred resource set (e.g., ignore part non-preferred resources).
Option 1: The subset of non-preferred resources for the exclusion is determined before the start of iterative resource selection and exclusion procedure.

The number of non-preferred resources which guarantees stop criteria may be estimated using the threshold value for the number of resources in remaining candidate resource set S_{Cand_Remain} and total number of resources in set SA obtained after element 5a). Once the maximum number of non-preferred resources that may be processed is determined, the subset of non-preferred resources may also be determined. In one embodiment, the specified number of resources may be taken randomly from the full set of non-preferred resources.

Afterward, the identified subset(s) of non-preferred resources may be used as a S_{NP} set for resource exclusion in element 6a)
Option 2: The subset of non-preferred resources excluded from the candidate resource set is determined at each iteration of the resource selection

In this case the subset of non-preferred resources that can be excluded from identified candidate resource set may be determine implicitly or explicitly.
Alternative 1: Explicit determination of the subset of non-preferred resources for exclusion from identified candidate resource set

The set of non-preferred resources may be determined explicitly in accordance with the following example technique (although, in other embodiments, one or more different elements or techniques may additionally/alternatively be used):
Element 1: Find the set of non-preferred resources that are present in identified candidate resource set (S_{Cand_NP}). This operation can be implemented using set intersection operation between the set of non-preferred resources (S_{NP}) and set identified candidate resource set (S_{Cand}), e.g. S_{Cand_NP}=S_{Cand} ∩ S_{NP}.
Element 2: Calculate the maximum number of non-preferred resources (M_{Cand_NP_Excl_Max}) that can be excluded from identified candidate resource set S_{Cand} in a way that remaining resource set S_{Cand} satisfy stop condition.
Element 3: Among S_{Cand_NP} resource set determine maximum set S_{cand_NP_Excl_Max} of non-preferred resources of M_{Cand_NP_Excl_Max} size that can be excluded from identified candidate resource set. In one embodiment, the non-preferred resources may be selected randomly, if the full number of non-preferred resources exceeds the M_{Cand_NP_Excl_Max}.

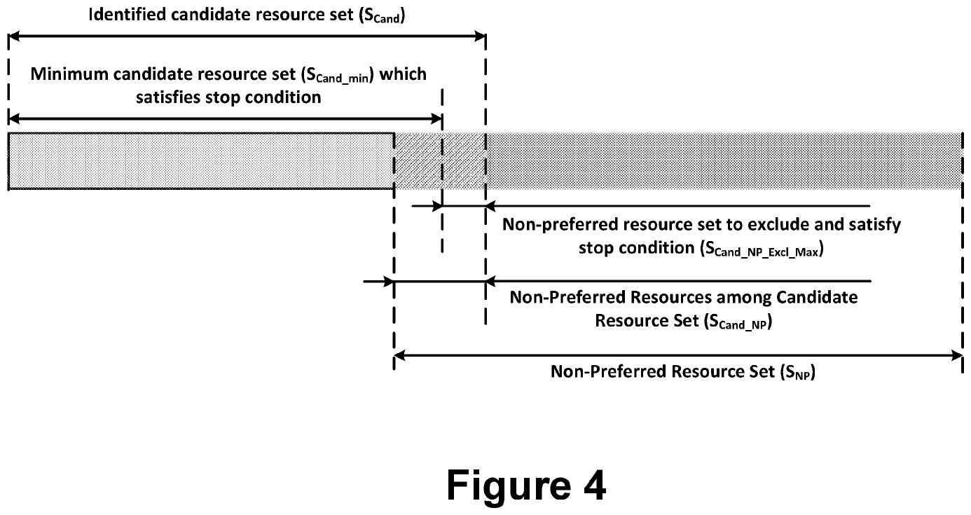

An example relationship between S_{Cand}, S_{NP}, S_{Cand_NP}, S_{Cand_NP_Excl_Max} sets is illustrated in FIG. 4.
Alternative 2: Implicit determination of the subset of non-preferred resources for exclusion from identified candidate resource set

The set of non-preferred resources excluded from the identified candidate resource set may be implicitly during the execution of the non-preferred resources exclusion.

In one embodiment, the resources from the non-preferred resource set may be excluded from identified candidate resource set while the number of resources in remaining candidate resource set satisfies threshold from the used stop condition.

In another embodiment, a full non-preferred resource set may be excluded from the identified candidate resource set. If the number of resources in the remaining candidate resource set is less than predefined threshold, the non-preferred resource set may be reduced, and the non-preferred resource set exclusion procedure may be repeated until the size of the remaining candidate resource set exceeds the threshold from the used stop condition.

In addition, to overcome the issue that only a few non-preferred resources are excluded, the threshold on the minimum number of excluded non-preferred resources (M_{Non-pref_min}) may be introduced. In this case, at least predefined number of non-preferred resources may be excluded. If it not possible, the RSRP threshold may be increased, and procedure should be repeated.

### Definition of the Minimum Number of Excluded Non-Preferred Resources Threshold

Threshold on size of candidate resource set may be defined using one or more of the following example options (although one or more other options may be used in additional/alternative embodiments):
1) Ratio of the non-preferred resources to be excluded to total number of non-preferred resources; and/or
2) Absolute number of non-preferred resources to be excluded

### Example Procedures

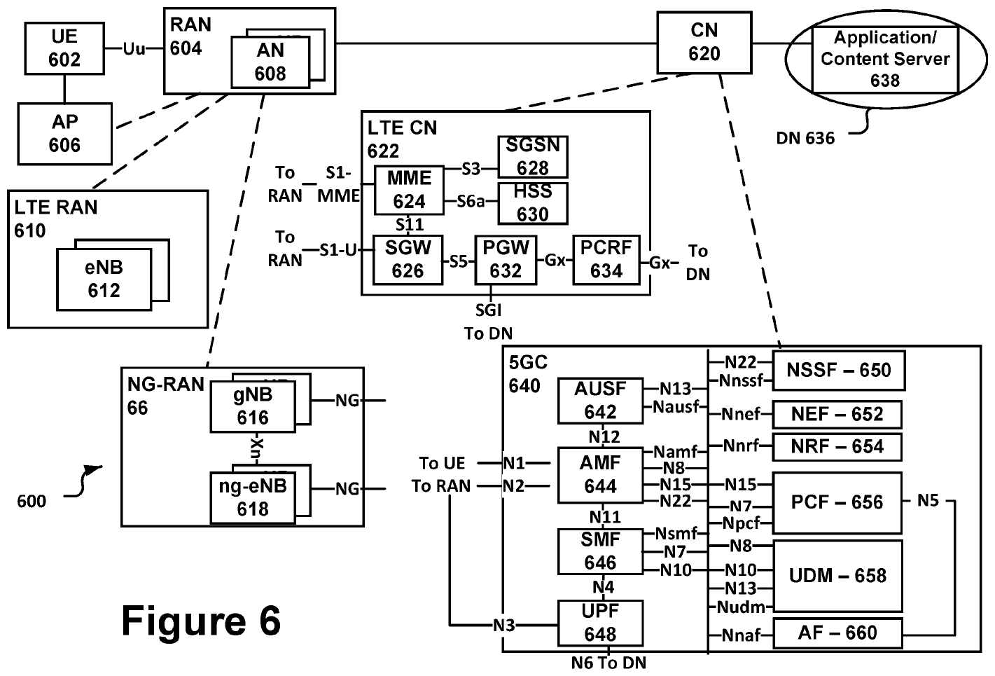

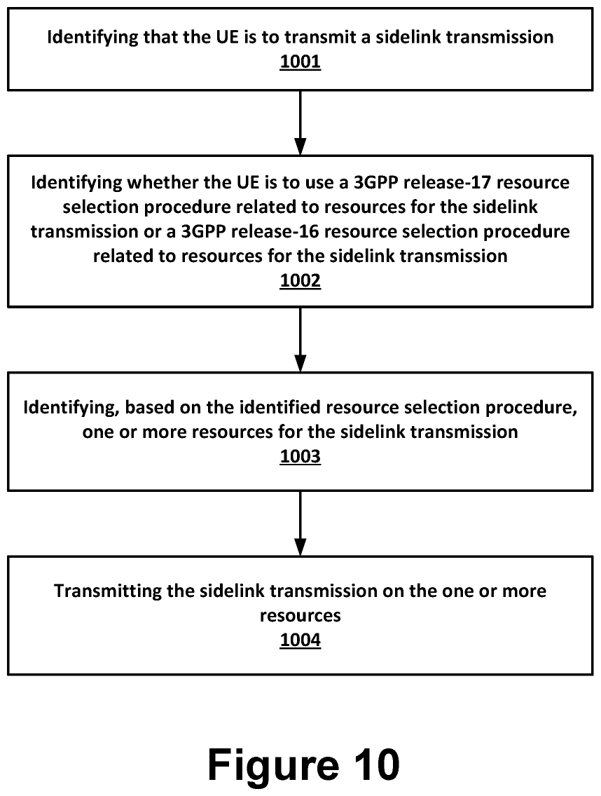

In some embodiments, the electronic device(s), network(s), system(s), chip(s) or component(s), or portions or implementations thereof, of FIGS. 6-9, or some other figure herein, may be configured to perform one or more processes, techniques, or methods as described herein, or portions thereof. One such process is depicted in FIG. 10. The process of FIG. 10 may include or relate to a method to be performed by a user equipment (UE), one or more elements of a UE, and/or an electronic device that includes and/or implements a UE. The process of FIG. 10 may include: identifying, at 1001, that the UE is to transmit a sidelink transmission; identifying, at 1002, whether the UE is to use a third generation partnership project (3GPP) release-17 resource selection procedure related to resources for the sidelink transmission or a 3GPP release-16 resource selection procedure related to resources for the sidelink transmission; identifying, at 1003 based on the identified resource selection procedure, one or more resources for the sidelink transmission; and transmitting, at 1004, the sidelink transmission on the one or more resources.

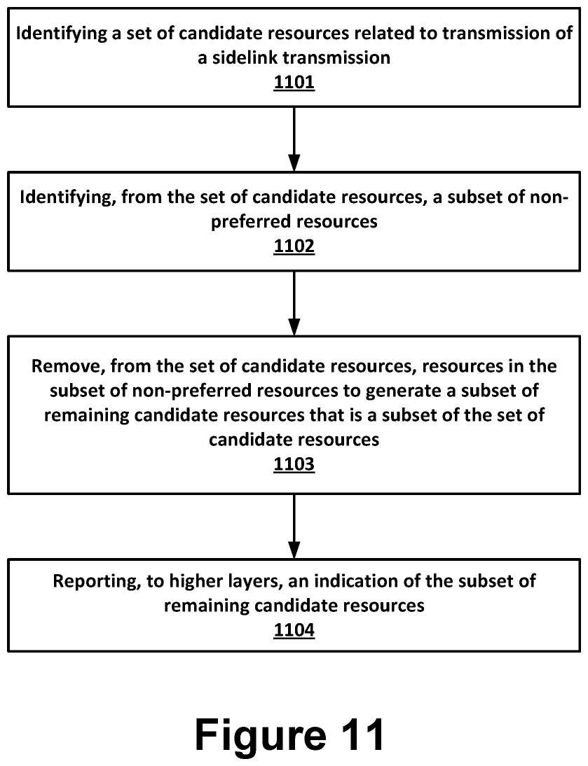

Another such process is depicted in FIG. 11. The process of FIG. 11 may include or relate to a method to be performed by a user equipment (UE), one or more elements of a UE, and/or an electronic device that includes and/or implements a UE. The process of FIG. 11 may include identifying, at 1101, a set of candidate resources related to transmission of a sidelink transmission; identify, at 1102 from the set of candidate resources, a subset of non-preferred resources; removing, at 1103 from the set of candidate resources, resources in the subset of non-preferred resources to generate a subset of remaining candidate resources that is a subset of the set of candidate resources; and reporting, at 1104 to higher layers, an indication of the subset of remaining candidate resources.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### Systems and Implementations

FIGS. 6-9 illustrate various systems, devices, and components that may implement aspects of disclosed embodiments.

FIG. 6 illustrates a network 600 in accordance with various embodiments. The network 600 may operate in a manner consistent with 3GPP technical specifications for LTE or 5G/NR systems. However, the example embodiments are not limited in this regard and the described embodiments may apply to other networks that benefit from the principles described herein, such as future 3GPP systems, or the like.

The network 600 may include a UE 602, which may include any mobile or non-mobile computing device designed to communicate with a RAN 604 via an over-the-air connection. The UE 602 may be communicatively coupled with the RAN 604 by a Uu interface. The UE 602 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

In some embodiments, the network 600 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc.

In some embodiments, the UE 602 may additionally communicate with an AP 606 via an over-the-air connection. The AP 606 may manage a WLAN connection, which may serve to offload some/all network traffic from the RAN 604. The connection between the UE 602 and the AP 606 may be consistent with any IEEE 802.11 protocol, wherein the AP 606 could be a wireless fidelity (Wi-Fi®) router. In some embodiments, the UE 602, RAN 604, and AP 606 may utilize cellular-WLAN aggregation (for example, LWA/LWIP). Cellular-WLAN aggregation may involve the UE 602 being configured by the RAN 604 to utilize both cellular radio resources and WLAN resources.

The RAN 604 may include one or more access nodes, for example, AN 608. AN 608 may terminate air-interface protocols for the UE 602 by providing access stratum protocols including RRC, PDCP, RLC, MAC, and LI protocols. In this manner, the AN 608 may enable data/voice connectivity between CN 620 and the UE 602. In some embodiments, the AN 608 may be implemented in a discrete device or as one or more software entities running on server computers as part of, for example, a virtual network, which may be referred to as a CRAN or virtual baseband unit pool. The AN 608 be referred to as a BS, gNB, RAN node, eNB, ng-eNB, NodeB, RSU, TRxP, TRP, etc. The AN 608 may be a macrocell base station or a low power base station for providing femtocells, picocells or other like cells having smaller coverage areas, smaller user capacity, or higher bandwidth compared to macrocells.

In embodiments in which the RAN 604 includes a plurality of ANs, they may be coupled with one another via an X2 interface (if the RAN 604 is an LTE RAN) or an Xn interface (if the RAN 604 is a 5G RAN). The X2/Xn interfaces, which may be separated into control/user plane interfaces in some embodiments, may allow the ANs to communicate information related to handovers, data/context transfers, mobility, load management, interference coordination, etc.

The ANs of the RAN 604 may each manage one or more cells, cell groups, component carriers, etc. to provide the UE 602 with an air interface for network access. The UE 602 may be simultaneously connected with a plurality of cells provided by the same or different ANs of the RAN 604. For example, the UE 602 and RAN 604 may use carrier aggregation to allow the UE 602 to connect with a plurality of component carriers, each corresponding to a Pcell or Scell. In dual connectivity scenarios, a first AN may be a master node that provides an MCG and a second AN may be secondary node that provides an SCG. The first/second ANs may be any combination of eNB, gNB, ng-eNB, etc.

The RAN 604 may provide the air interface over a licensed spectrum or an unlicensed spectrum. To operate in the unlicensed spectrum, the nodes may use LAA, eLAA, and/or feLAA mechanisms based on CA technology with PCells/Scells. Prior to accessing the unlicensed spectrum, the nodes may perform medium/carrier-sensing operations based on, for example, a listen-before-talk (LBT) protocol.

In V2X scenarios the UE 602 or AN 608 may be or act as a RSU, which may refer to any transportation infrastructure entity used for V2X communications. An RSU may be implemented in or by a suitable AN or a stationary (or relatively stationary) UE. An RSU implemented in or by: a UE may be referred to as a “UE-type RSU”; an eNB may be referred to as an “eNB-type RSU”; a gNB may be referred to as a “gNB-type RSU”; and the like. In one example, an RSU is a computing device coupled with radio frequency circuitry located on a roadside that provides connectivity support to passing vehicle UEs. The RSU may also include internal data storage circuitry to store intersection map geometry, traffic statistics, media, as well as applications/software to sense and control ongoing vehicular and pedestrian traffic. The RSU may provide very low latency communications required for high speed events, such as crash avoidance, traffic warnings, and the like. Additionally or alternatively, the RSU may provide other cellular/WLAN communications services. The components of the RSU may be packaged in a weatherproof enclosure suitable for outdoor installation, and may include a network interface controller to provide a wired connection (e.g., Ethernet) to a traffic signal controller or a backhaul network.

In some embodiments, the RAN 604 may be an LTE RAN 610 with eNBs, for example, eNB 612. The LTE RAN 610 may provide an LTE air interface with the following characteristics: SCS of 15 kHz; CP-OFDM waveform for DL and SC-FDMA waveform for UL; turbo codes for data and TBCC for control; etc. The LTE air interface may rely on CSI-RS for CSI acquisition and beam management; PDSCH/PDCCH DMRS for PDSCH/PDCCH demodulation; and CRS for cell search and initial acquisition, channel quality measurements, and channel estimation for coherent demodulation/detection at the UE. The LTE air interface may operating on sub-6 GHz bands.

In some embodiments, the RAN 604 may be an NG-RAN 614 with gNBs, for example, gNB 616, or ng-eNBs, for example, ng-eNB 618. The gNB 616 may connect with 5G-enabled UEs using a 5G NR interface. The gNB 616 may connect with a 5G core through an NG interface, which may include an N2 interface or an N3 interface. The ng-eNB 618 may also connect with the 5G core through an NG interface, but may connect with a UE via an LTE air interface. The gNB 616 and the ng-eNB 618 may connect with each other over an Xn interface.

In some embodiments, the NG interface may be split into two parts, an NG user plane (NG-U) interface, which carries traffic data between the nodes of the NG-RAN 614 and a UPF 648 (e.g., N3 interface), and an NG control plane (NG-C) interface, which is a signaling interface between the nodes of the NG-RAN614 and an AMF 644 (e.g., N2 interface).

The NG-RAN 614 may provide a 5G-NR air interface with the following characteristics: variable SCS; CP-OFDM for DL, CP-OFDM and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operating on FR1 bands that include sub-6 GHz bands or FR2 bands that include bands from 24.25 GHz to 52.6 GHz. The 5G-NR air interface may include an SSB that is an area of a downlink resource grid that includes PSS/SSS/PBCH.

In some embodiments, the 5G-NR air interface may utilize BWPs for various purposes. For example, BWP can be used for dynamic adaptation of the SCS. For example, the UE 602 can be configured with multiple BWPs where each BWP configuration has a different SCS. When a BWP change is indicated to the UE 602, the SCS of the transmission is changed as well. Another use case example of BWP is related to power saving. In particular, multiple BWPs can be configured for the UE 602 with different amount of frequency resources (for example, PRBs) to support data transmission under different traffic loading scenarios. A BWP containing a smaller number of PRBs can be used for data transmission with small traffic load while allowing power saving at the UE 602 and in some cases at the gNB 616. A BWP containing a larger number of PRBs can be used for scenarios with higher traffic load.

The RAN 604 is communicatively coupled to CN 620 that includes network elements to provide various functions to support data and telecommunications services to customers/subscribers (for example, users of UE 602). The components of the CN 620 may be implemented in one physical node or separate physical nodes. In some embodiments, NFV may be utilized to virtualize any or all of the functions provided by the network elements of the CN 620 onto physical compute/storage resources in servers, switches, etc. A logical instantiation of the CN 620 may be referred to as a network slice, and a logical instantiation of a portion of the CN 620 may be referred to as a network sub-slice.

In some embodiments, the CN 620 may be an LTE CN 622, which may also be referred to as an EPC. The LTE CN 622 may include MME 624, SGW 626, SGSN 628, HSS 630, PGW 632, and PCRF 634 coupled with one another over interfaces (or “reference points”) as shown. Functions of the elements of the LTE CN 622 may be briefly introduced as follows.

The MME 624 may implement mobility management functions to track a current location of the UE 602 to facilitate paging, bearer activation/deactivation, handovers, gateway selection, authentication, etc.

The SGW 626 may terminate an SI interface toward the RAN and route data packets between the RAN and the LTE CN 622. The SGW 626 may be a local mobility anchor point for inter-RAN node handovers and also may provide an anchor for inter-3GPP mobility. Other responsibilities may include lawful intercept, charging, and some policy enforcement.

The SGSN 628 may track a location of the UE 602 and perform security functions and access control. In addition, the SGSN 628 may perform inter-EPC node signaling for mobility between different RAT networks; PDN and S-GW selection as specified by MME 624; MME selection for handovers; etc. The S3 reference point between the MME 624 and the SGSN 628 may enable user and bearer information exchange for inter-3GPP access network mobility in idle/active states.

The HSS 630 may include a database for network users, including subscription-related information to support the network entities' handling of communication sessions. The HSS 630 can provide support for routing/roaming, authentication, authorization, naming/addressing resolution, location dependencies, etc. An S6a reference point between the HSS 630 and the MME 624 may enable transfer of subscription and authentication data for authenticating/authorizing user access to the LTE CN 620.

The PGW 632 may terminate an SGi interface toward a data network (DN) 636 that may include an application/content server 638. The PGW 632 may route data packets between the LTE CN 622 and the data network 636. The PGW 632 may be coupled with the SGW 626 by an S5 reference point to facilitate user plane tunneling and tunnel management. The PGW 632 may further include a node for policy enforcement and charging data collection (for example, PCEF). Additionally, the SGi reference point between the PGW 632 and the data network 636 may be an operator external public, a private PDN, or an intra-operator packet data network, for example, for provision of IMS services. The PGW 632 may be coupled with a PCRF 634 via a Gx reference point.

The PCRF 634 is the policy and charging control element of the LTE CN 622. The PCRF 634 may be communicatively coupled to the app/content server 638 to determine appropriate QoS and charging parameters for service flows. The PCRF 632 may provision associated rules into a PCEF (via Gx reference point) with appropriate TFT and QCI.

In some embodiments, the CN 620 may be a 5GC 640. The 5GC 640 may include an AUSF 642, AMF 644, SMF 646, UPF 648, NSSF 650, NEF 652, NRF 654, PCF 656, UDM 658, and AF 660 coupled with one another over interfaces (or “reference points”) as shown. Functions of the elements of the 5GC 640 may be briefly introduced as follows.

The AUSF 642 may store data for authentication of UE 602 and handle authentication-related functionality. The AUSF 642 may facilitate a common authentication framework for various access types. In addition to communicating with other elements of the 5GC 640 over reference points as shown, the AUSF 642 may exhibit an Nausf service-based interface.

The AMF 644 may allow other functions of the 5GC 640 to communicate with the UE 602 and the RAN 604 and to subscribe to notifications about mobility events with respect to the UE 602. The AMF 644 may be responsible for registration management (for example, for registering UE 602), connection management, reachability management, mobility management, lawful interception of AMF-related events, and access authentication and authorization. The AMF 644 may provide transport for SM messages between the UE 602 and the SMF 646, and act as a transparent proxy for routing SM messages. AMF 644 may also provide transport for SMS messages between UE 602 and an SMSF. AMF 644 may interact with the AUSF 642 and the UE 602 to perform various security anchor and context management functions. Furthermore, AMF 644 may be a termination point of a RAN CP interface, which may include or be an N2 reference point between the RAN 604 and the AMF 644; and the AMF 644 may be a termination point of NAS (N1) signaling, and perform NAS ciphering and integrity protection. AMF 644 may also support NAS signaling with the UE 602 over an N3 IWF interface.

The SMF 646 may be responsible for SM (for example, session establishment, tunnel management between UPF 648 and AN 608); UE IP address allocation and management (including optional authorization); selection and control of UP function; configuring traffic steering at UPF 648 to route traffic to proper destination; termination of interfaces toward policy control functions; controlling part of policy enforcement, charging, and QoS; lawful intercept (for SM events and interface to LI system); termination of SM parts of NAS messages; downlink data notification; initiating AN specific SM information, sent via AMF 644 over N2 to AN 608; and determining SSC mode of a session. SM may refer to management of a PDU session, and a PDU session or “session” may refer to a PDU connectivity service that provides or enables the exchange of PDUs between the UE 602 and the data network 636.

The UPF 648 may act as an anchor point for intra-RAT and inter-RAT mobility, an external PDU session point of interconnect to data network 636, and a branching point to support multi-homed PDU session. The UPF 648 may also perform packet routing and forwarding, perform packet inspection, enforce the user plane part of policy rules, lawfully intercept packets (UP collection), perform traffic usage reporting, perform QoS handling for a user plane (e.g., packet filtering, gating, UL/DL rate enforcement), perform uplink traffic verification (e.g., SDF-to-QoS flow mapping), transport level packet marking in the uplink and downlink, and perform downlink packet buffering and downlink data notification triggering. UPF 648 may include an uplink classifier to support routing traffic flows to a data network.

The NSSF 650 may select a set of network slice instances serving the UE 602. The NSSF 650 may also determine allowed NSSAI and the mapping to the subscribed S-NSSAIs, if needed. The NSSF 650 may also determine the AMF set to be used to serve the UE 602, or a list of candidate AMFs based on a suitable configuration and possibly by querying the NRF 654. The selection of a set of network slice instances for the UE 602 may be triggered by the AMF 644 with which the UE 602 is registered by interacting with the NSSF 650, which may lead to a change of AMF. The NSSF 650 may interact with the AMF 644 via an N22 reference point; and may communicate with another NSSF in a visited network via an N31 reference point (not shown). Additionally, the NSSF 650 may exhibit an Nnssf service-based interface.

The NEF 652 may securely expose services and capabilities provided by 3GPP network functions for third party, internal exposure/re-exposure, AFs (e.g., AF 660), edge computing or fog computing systems, etc. In such embodiments, the NEF 652 may authenticate, authorize, or throttle the AFs. NEF 652 may also translate information exchanged with the AF 660 and information exchanged with internal network functions. For example, the NEF 652 may translate between an AF-Service-Identifier and an internal 5GC information. NEF 652 may also receive information from other NFs based on exposed capabilities of other NFs. This information may be stored at the NEF 652 as structured data, or at a data storage NF using standardized interfaces. The stored information can then be re-exposed by the NEF 652 to other NFs and AFs, or used for other purposes such as analytics. Additionally, the NEF 652 may exhibit an Nnef service-based interface.

The NRF 654 may support service discovery functions, receive NF discovery requests from NF instances, and provide the information of the discovered NF instances to the NF instances. NRF 654 also maintains information of available NF instances and their supported services. As used herein, the terms “instantiate,” “instantiation,” and the like may refer to the creation of an instance, and an “instance” may refer to a concrete occurrence of an object, which may occur, for example, during execution of program code. Additionally, the NRF 654 may exhibit the Nnrf service-based interface.

The PCF 656 may provide policy rules to control plane functions to enforce them, and may also support unified policy framework to govern network behavior. The PCF 656 may also implement a front end to access subscription information relevant for policy decisions in a UDR of the UDM 658. In addition to communicating with functions over reference points as shown, the PCF 656 exhibit an Npcf service-based interface.

The UDM 658 may handle subscription-related information to support the network entities' handling of communication sessions, and may store subscription data of UE 602. For example, subscription data may be communicated via an N8 reference point between the UDM 658 and the AMF 644. The UDM 658 may include two parts, an application front end and a UDR. The UDR may store subscription data and policy data for the UDM 658 and the PCF 656, and/or structured data for exposure and application data (including PFDs for application detection, application request information for multiple UEs 602) for the NEF 652. The Nudr service-based interface may be exhibited by the UDR 221 to allow the UDM 658, PCF 656, and NEF 652 to access a particular set of the stored data, as well as to read, update (e.g., add, modify), delete, and subscribe to notification of relevant data changes in the UDR. The UDM may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 658 may exhibit the Nudm service-based interface.

The AF 660 may provide application influence on traffic routing, provide access to NEF, and interact with the policy framework for policy control.

In some embodiments, the 5GC 640 may enable edge computing by selecting operator/3rd party services to be geographically close to a point that the UE 602 is attached to the network. This may reduce latency and load on the network. To provide edge-computing implementations, the 5GC 640 may select a UPF 648 close to the UE 602 and execute traffic steering from the UPF 648 to data network 636 via the N6 interface. This may be based on the UE subscription data, UE location, and information provided by the AF 660. In this way, the AF 660 may influence UPF (re) selection and traffic routing. Based on operator deployment, when AF 660 is considered to be a trusted entity, the network operator may permit AF 660 to interact directly with relevant NFs. Additionally, the AF 660 may exhibit an Naf service-based interface.

The data network 636 may represent various network operator services, Internet access, or third party services that may be provided by one or more servers including, for example, application/content server 638.

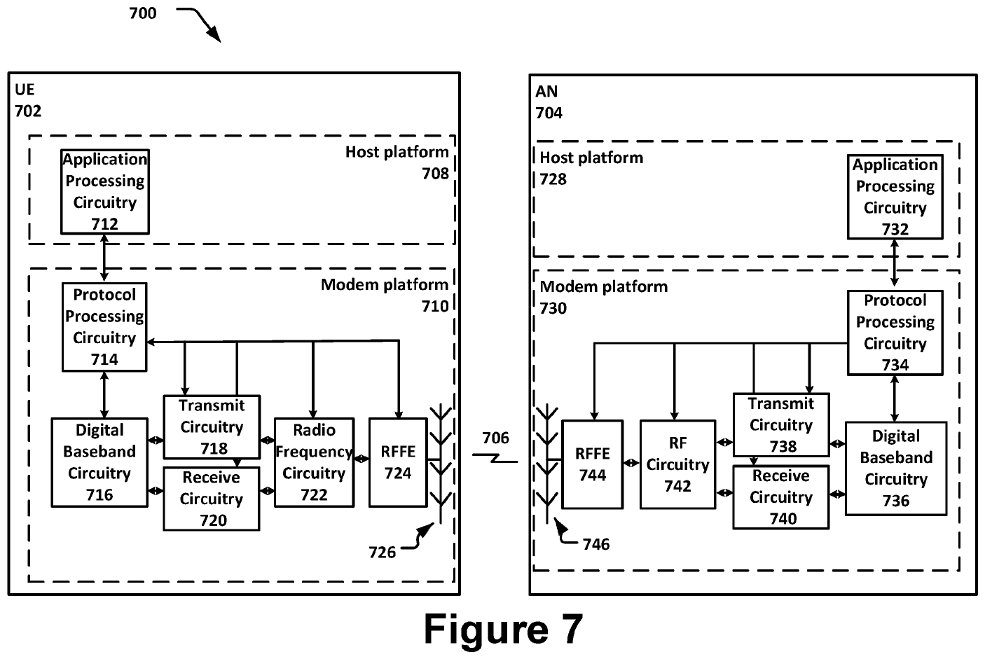

FIG. 7 schematically illustrates a wireless network 700 in accordance with various embodiments. The wireless network 700 may include a UE 702 in wireless communication with an AN 704. The UE 702 and AN 704 may be similar to, and substantially interchangeable with, like-named components described elsewhere herein.

The UE 702 may be communicatively coupled with the AN 704 via connection 706. The connection 706 is illustrated as an air interface to enable communicative coupling, and can be consistent with cellular communications protocols such as an LTE protocol or a 5G NR protocol operating at mm Wave or sub-6 GHZ frequencies.

The UE 702 may include a host platform 708 coupled with a modem platform 710. The host platform 708 may include application processing circuitry 712, which may be coupled with protocol processing circuitry 714 of the modem platform 710. The application processing circuitry 712 may run various applications for the UE 702 that source/sink application data. The application processing circuitry 712 may further implement one or more layer operations to transmit/receive application data to/from a data network. These layer operations may include transport (for example UDP) and Internet (for example, IP) operations

The protocol processing circuitry 714 may implement one or more of layer operations to facilitate transmission or reception of data over the connection 706. The layer operations implemented by the protocol processing circuitry 714 may include, for example, MAC, RLC, PDCP, RRC and NAS operations.

The modem platform 710 may further include digital baseband circuitry 716 that may implement one or more layer operations that are “below” layer operations performed by the protocol processing circuitry 714 in a network protocol stack. These operations may include, for example, PHY operations including one or more of HARQ-ACK functions, scrambling/descrambling, encoding/decoding, layer mapping/de-mapping, modulation symbol mapping, received symbol/bit metric determination, multi-antenna port precoding/decoding, which may include one or more of space-time, space-frequency or spatial coding, reference signal generation/detection, preamble sequence generation and/or decoding, synchronization sequence generation/detection, control channel signal blind decoding, and other related functions.

The modem platform 710 may further include transmit circuitry 718, receive circuitry 720, RF circuitry 722, and RF front end (RFFE) 724, which may include or connect to one or more antenna panels 726. Briefly, the transmit circuitry 718 may include a digital-to-analog converter, mixer, intermediate frequency (IF) components, etc.; the receive circuitry 720 may include an analog-to-digital converter, mixer, IF components, etc.; the RF circuitry 722 may include a low-noise amplifier, a power amplifier, power tracking components, etc.; RFFE 724 may include filters (for example, surface/bulk acoustic wave filters), switches, antenna tuners, beamforming components (for example, phase-array antenna components), etc. The selection and arrangement of the components of the transmit circuitry 718, receive circuitry 720, RF circuitry 722, RFFE 724, and antenna panels 726 (referred generically as “transmit/receive components”) may be specific to details of a specific implementation such as, for example, whether communication is TDM or FDM, in mmWave or sub-6 gHz frequencies, etc. In some embodiments, the transmit/receive components may be arranged in multiple parallel transmit/receive chains, may be disposed in the same or different chips/modules, etc.

In some embodiments, the protocol processing circuitry 714 may include one or more instances of control circuitry (not shown) to provide control functions for the transmit/receive components.

A UE reception may be established by and via the antenna panels 726, RFFE 724, RF circuitry 722, receive circuitry 720, digital baseband circuitry 716, and protocol processing circuitry 714. In some embodiments, the antenna panels 726 may receive a transmission from the AN 704 by receive-beamforming signals received by a plurality of antennas/antenna elements of the one or more antenna panels 726.

A UE transmission may be established by and via the protocol processing circuitry 714, digital baseband circuitry 716, transmit circuitry 718, RF circuitry 722, RFFE 724, and antenna panels 726. In some embodiments, the transmit components of the UE 704 may apply a spatial filter to the data to be transmitted to form a transmit beam emitted by the antenna elements of the antenna panels 726.

Similar to the UE 702, the AN 704 may include a host platform 728 coupled with a modem platform 730. The host platform 728 may include application processing circuitry 732 coupled with protocol processing circuitry 734 of the modem platform 730. The modem platform may further include digital baseband circuitry 736, transmit circuitry 738, receive circuitry 740, RF circuitry 742, RFFE circuitry 744, and antenna panels 746. The components of the AN 704 may be similar to and substantially interchangeable with like-named components of the UE 702. In addition to performing data transmission/reception as described above, the components of the AN 708 may perform various logical functions that include, for example, RNC functions such as radio bearer management, uplink and downlink dynamic radio resource management, and data packet scheduling.

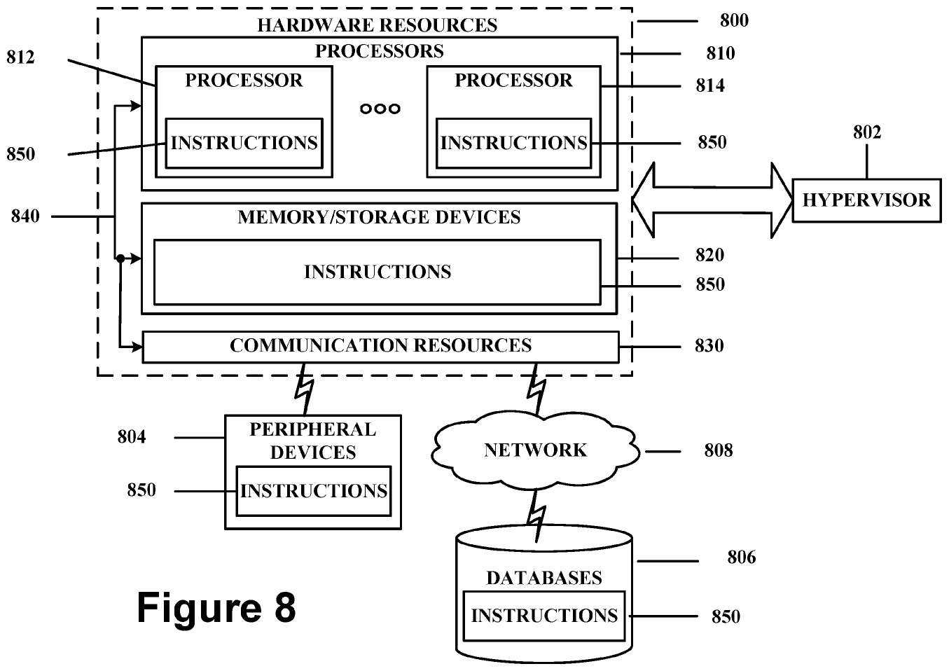

FIG. 8 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 8 shows a diagrammatic representation of hardware resources 800 including one or more processors (or processor cores) 810, one or more memory/storage devices 820, and one or more communication resources 830, each of which may be communicatively coupled via a bus 840 or other interface circuitry. For embodiments where node virtualization (e.g., NFV) is utilized, a hypervisor 802 may be executed to provide an execution environment for one or more network slices/sub-slices to utilize the hardware resources 800.

The processors 810 may include, for example, a processor 812 and a processor 814. The processors 810 may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), another processor (including those discussed herein), or any suitable combination thereof.

The memory/storage devices 820 may include main memory, disk storage, or any suitable combination thereof. The memory/storage devices 820 may include, but are not limited to, any type of volatile, non-volatile, or semi-volatile memory such as dynamic random access memory (DRAM), static random access memory (SRAM), erasable programmable read-only memory (EPROM), electrically erasable programmable read-only memory (EEPROM), Flash memory, solid-state storage, etc.

The communication resources 830 may include interconnection or network interface controllers, components, or other suitable devices to communicate with one or more peripheral devices 804 or one or more databases 806 or other network elements via a network 808. For example, the communication resources 830 may include wired communication components (e.g., for coupling via USB, Ethernet, etc.), cellular communication components, NFC components, Bluetooth® (or Bluetooth® Low Energy) components, Wi-Fi® components, and other communication components.

Instructions 850 may comprise software, a program, an application, an applet, an app, or other executable code for causing at least any of the processors 810 to perform any one or more of the methodologies discussed herein. The instructions 850 may reside, completely or partially, within at least one of the processors 810 (e.g., within the processor's cache memory), the memory/storage devices 820, or any suitable combination thereof. Furthermore, any portion of the instructions 850 may be transferred to the hardware resources 800 from any combination of the peripheral devices 804 or the databases 806. Accordingly, the memory of processors 810, the memory/storage devices 820, the peripheral devices 804, and the databases 806 are examples of computer-readable and machine-readable media.

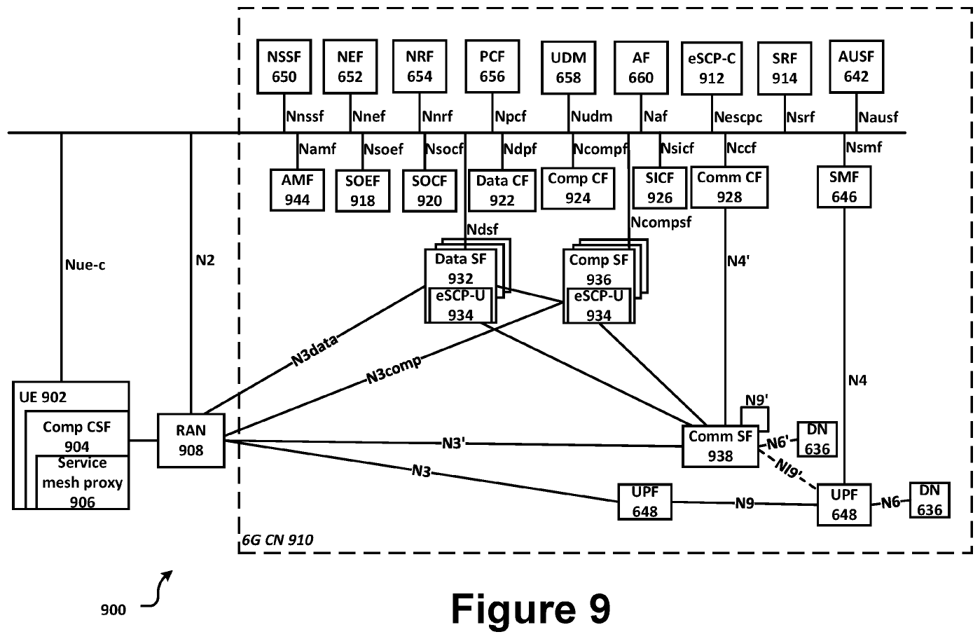

FIG. 9 illustrates a network 900 in accordance with various embodiments. The network 900 may operate in a matter consistent with 3GPP technical specifications or technical reports for 6G systems. In some embodiments, the network 900 may operate concurrently with network 600. For example, in some embodiments, the network 900 may share one or more frequency or bandwidth resources with network 600. As one specific example, a UE (e.g., UE 902) may be configured to operate in both network 900 and network 600. Such configuration may be based on a UE including circuitry configured for communication with frequency and bandwidth resources of both networks 600 and 900. In general, several elements of network 900 may share one or more characteristics with elements of network 600. For the sake of brevity and clarity, such elements may not be repeated in the description of network 900.

The network 900 may include a UE 902, which may include any mobile or non-mobile computing device designed to communicate with a RAN 908 via an over-the-air connection. The UE 902 may be similar to, for example, UE 602. The UE 902 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

Although not specifically shown in FIG. 9, in some embodiments the network 900 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc. Similarly, although not specifically shown in FIG. 9, the UE 902 may be communicatively coupled with an AP such as AP 606 as described with respect to FIG. 6. Additionally, although not specifically shown in FIG. 9, in some embodiments the RAN 908 may include one or more ANss such as AN 608 as described with respect to FIG. 6. The RAN 908 and/or the AN of the RAN 908 may be referred to as a base station (BS), a RAN node, or using some other term or name.

The UE 902 and the RAN 908 may be configured to communicate via an air interface that may be referred to as a sixth generation (6G) air interface. The 6G air interface may include one or more features such as communication in a terahertz (THz) or sub-THz bandwidth, or joint communication and sensing. As used herein, the term “joint communication and sensing” may refer to a system that allows for wireless communication as well as radar-based sensing via various types of multiplexing. As used herein, THz or sub-THz bandwidths may refer to communication in the 80 GHz and above frequency ranges. Such frequency ranges may additionally or alternatively be referred to as “millimeter wave” or “mmWave” frequency ranges.

The RAN 908 may allow for communication between the UE 902 and a 6G core network (CN) 910. Specifically, the RAN 908 may facilitate the transmission and reception of data between the UE 902 and the 6G CN 910. The 6G CN 910 may include various functions such as NSSF 650, NEF 652, NRF 654, PCF 656, UDM 658, AF 660, SMF 646, and AUSF 642. The 6G CN 910 may additional include UPF 648 and DN 636 as shown in FIG. 9.

Additionally, the RAN 908 may include various additional functions that are in addition to, or alternative to, functions of a legacy cellular network such as a 4G or 5G network. Two such functions may include a Compute Control Function (Comp CF) 924 and a Compute Service Function (Comp SF) 936. The Comp CF 924 and the Comp SF 936 may be parts or functions of the Computing Service Plane. Comp CF 924 may be a control plane function that provides functionalities such as management of the Comp SF 936, computing task context generation and management (e.g., create, read, modify, delete), interaction with the underlying computing infrastructure for computing resource management, etc., Comp SF 936 may be a user plane function that serves as the gateway to interface computing service users (such as UE 902) and computing nodes behind a Comp SF instance. Some functionalities of the Comp SF 936 may include: parse computing service data received from users to compute tasks executable by computing nodes; hold service mesh ingress gateway or service API gateway; service and charging policies enforcement; performance monitoring and telemetry collection, etc. In some embodiments, a Comp SF 936 instance may serve as the user plane gateway for a cluster of computing nodes. A Comp CF 924 instance may control one or more Comp SF 936 instances.

Two other such functions may include a Communication Control Function (Comm CF) 928 and a Communication Service Function (Comm SF) 938, which may be parts of the Communication Service Plane. The Comm CF 928 may be the control plane function for managing the Comm SF 938, communication sessions creation/configuration/releasing, and managing communication session context. The Comm SF 938 may be a user plane function for data transport. Comm CF 928 and Comm SF 938 may be considered as upgrades of SMF 646 and UPF 648, which were described with respect to a 5G system in FIG. 6. The upgrades provided by the Comm CF 928 and the Comm SF 938 may enable service-aware transport. For legacy (e.g., 4G or 5G) data transport, SMF 646 and UPF 648 may still be used.

Two other such functions may include a Data Control Function (Data CF) 922 and Data Service Function (Data SF) 932 may be parts of the Data Service Plane. Data CF 922 may be a control plane function and provides functionalities such as Data SF 932 management, Data service creation/configuration/releasing, Data service context management, etc. Data SF 932 may be a user plane function and serve as the gateway between data service users (such as UE 902 and the various functions of the 6G CN 910) and data service endpoints behind the gateway. Specific functionalities may include include: parse data service user data and forward to corresponding data service endpoints, generate charging data, report data service status.

Another such function may be the Service Orchestration and Chaining Function (SOCF) 920, which may discover, orchestrate and chain up communication/computing/data services provided by functions in the network. Upon receiving service requests from users, SOCF 920 may interact with one or more of Comp CF 924, Comm CF 928, and Data CF 922 to identify Comp SF 936, Comm SF 938, and Data SF 932 instances, configure service resources, and generate the service chain, which could contain multiple Comp SF 936, Comm SF 938, and Data SF 932 instances and their associated computing endpoints. Workload processing and data movement may then be conducted within the generated service chain. The SOCF 920 may also responsible for maintaining, updating, and releasing a created service chain.

Another such function may be the service registration function (SRF) 914, which may act as a registry for system services provided in the user plane such as services provided by service endpoints behind Comp SF 936 and Data SF 932 gateways and services provided by the UE 902. The SRF 914 may be considered a counterpart of NRF 654, which may act as the registry for network functions.

Other such functions may include an evolved service communication proxy (eSCP) and service infrastructure control function (SICF) 926, which may provide service communication infrastructure for control plane services and user plane services. The eSCP may be related to the service communication proxy (SCP) of 5G with user plane service communication proxy capabilities being added. The eSCP is therefore expressed in two parts: eCSP-C 912 and eSCP-U 934, for control plane service communication proxy and user plane service communication proxy, respectively. The SICF 926 may control and configure eCSP instances in terms of service traffic routing policies, access rules, load balancing configurations, performance monitoring, etc.

Another such function is the AMF 944. The AMF 944 may be similar to 644, but with additional functionality. Specifically, the AMF 944 may include potential functional repartition, such as move the message forwarding functionality from the AMF 944 to the RAN 908.

Another such function is the service orchestration exposure function (SOEF) 918. The SOEF may be configured to expose service orchestration and chaining services to external users such as applications.

The UE 902 may include an additional function that is referred to as a computing client service function (comp CSF) 904. The comp CSF 904 may have both the control plane functionalities and user plane functionalities, and may interact with corresponding network side functions such as SOCF 920, Comp CF 924, Comp SF 936, Data CF 922, and/or Data SF 932 for service discovery, request/response, compute task workload exchange, etc. The Comp CSF 904 may also work with network side functions to decide on whether a computing task should be run on the UE 902, the RAN 908, and/or an element of the 6G CN 910.

The UE 902 and/or the Comp CSF 904 may include a service mesh proxy 906. The service mesh proxy 906 may act as a proxy for service-to-service communication in the user plane. Capabilities of the service mesh proxy 906 may include one or more of addressing, security, load balancing, etc.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

Example 1 may include a method of sidelink communication with inter-UE coordination wherein one or multiple assisting UEs generate and transmit IUC feedback and another one or multiple Transmit UEs receive feedback and make resource selection considering IUC feedback

Example 2 may include the method of example 1 or some other example herein, wherein the type of the used resource selection procedure is (pre-) configured for each type or subset of types of sidelink transmissions from at least the following set of transmission types:
Sidelink transmissions w/o IUC feedback or request for IUC feedback;
Sidelink transmissions which include IUC feedback;
Sidelink transmissions which include request for IUC feedback;
Sidelink transmissions which contain only IUC feedback;
Sidelink transmissions which contain only request for IUC feedback;
Sidelink transmissions with resource selection based on partial sensing;
Sidelink transmissions with resource selection based on full sensing; and/or
Sidelink transmissions with random resource selection procedures.

Example 3 may include the method of example 1 or some other example herein, wherein assisting UE is pre-configured with the maximum value for RSRP threshold used to determine whether resource is a preferred resource

Example 4 may include the method of example 1 or some other example herein, wherein TX UE treat resource as preferred in case of resource is included in both preferred and non-preferred resource sets only if pre-configuration signaling is provided. Otherwise, UE can treat such resource as non-preferred.

Example 5 may include the method of example 1 or some other example herein, wherein Assisting UE identifies resources in a slot as non-preferred resources due to Condition 1-B-2 if particular slot is a slot for which one or more of the following criteria satisfied:
Slots with reserved resources where half-duplex conflict was detected based on priority rules for sidelink reception and Assisting UE transmission (sidelink or uplink) resulting in half-duplex conflict for reception; and/or
Slots with reserved resources for transmission and potential half-duplex conflict (e.g., half-duplex conflict is not detected yet by UE-A but may happen due to future reservations made by TX-UEs).

Example 6 may include the method of example 1 or some other example herein, wherein Assisting UE identifies resources in a slot as non-preferred resources due to Condition 1-B-2 if particular slot is a slot for which one or more of the following criteria satisfied:
If UE-A is aware that reserved resource for transmission will not be used for actual transmission (e.g., due to ACK feedback or other reason) the reserved resource should not be indicated as non-preferred resource;
Slots with preselected but not reserved resources where half-duplex conflict was detected by UE-A based on priority rules for sidelink reception and UE-A transmission (sidelink or uplink) resulting in half-duplex conflict for reception; and/or
Slots with preselected but not reserved resources for transmission and potential half-duplex conflict (e.g., half-duplex conflict is not detected yet by UE-A but may happen due to future reservations made by TX-UEs).

Example 7 may include the method of example 7 or some other example herein, wherein the assisting UE is pre-configured whether to use one or multiple conditions from the specified set of conditions.

Example 8 may include the method of example 1 or some other example herein, wherein assisting and transmit UE implements one or more of the following design principles:
Content of request and/or condition-based inter-UE coordination information is transparent to cast type of sidelink transmission carrying inter-UE coordination feedback (Procedure for feedback generation is not aware about cast type of sidelink transmission carrying feedback);
Procedure for filtering inter-UE coordination information is defined to determine which of the received feedback and its content can be used to form preferred and non-preferred resource sets for resource selection;
Resource selection procedure is transparent to (1) cast type of inter-UE coordination information and (2) cast type and destination UE(s) of sidelink transmission;
Non-preferred resources corresponding to Condition 1-B-2 can be filtered out by TX-UE in some cases; and/or
Inter-UE coordination information (e.g., resources associated with conditions 1-A-1 & 1-A-2, 1-B-1) from both target and non-target receivers can be used to form preferred and non-preferred resource set for resource selection procedure (including resource exclusion and re-evaluation).

Example 9 may include the method of example 8 or some other example herein, wherein transmit UE implements IUC feedback filtering procedure.

Example 10 may include the method of example 9 or some other example herein, wherein IUC feedback filtering procedure may use one or more of the following parameters from IUC feedback to process IUC feedbacks and generate preferred and non-preferred resource sets for resource selection:
Cast type of IUC information/feedback;
Source (e.g., source ID) of IUC information/feedback;
Feedback generation timestamp (e.g., start/end slot of resource selection or sensing window, reference slot);
Number of subchannels per resource;
Resource selection window for feedback generation;
Priority used for IUC feedback generation;
Resource set type (e.g., preferred or non-preferred);
IUC feedback type (e.g., request based or condition based);
Resource sets (e.g., preferred, non-preferred resources); and/or
Reservation period for feedback generation.

Example 11 may include the method of example 9 or some other example herein, wherein IUC feedback filtering procedure may use one or more of the following parameters from IUC feedback to process IUC feedbacks and generate preferred and non-preferred resource sets for resource selection:
Cast type of sidelink transmission;
Destination (e.g., destination ID) of sidelink transmission;
Number of subchannels per sidelink resource for transmission;
Resource selection window for sidelink transmission (e.g., start/end slot of RSW)
Priority used of sidelink transmission; and/or
Reservation period for sidelink transmission.

Example 12 may include the method of examples 10, 11, or some other example herein, wherein IUC feedback filtering is based on priority information taken from IUC feedback and associated with Transmit UE sidelink transmission. IUC Feedbacks may be selected for further processing if condition from the specified list of alternatives is satisfied:
Alt. 1: Priority value used for feedback generation≤priority value of transmission.
Alt. 2: Priority value used for feedback generation==priority value of transmission.
Alt. 3: Priority value used for feedback generation ≥priority value of transmission

Example 13 may include the method of examples 10, 11, or some other example herein, wherein IUC feedback filtering is based on information on reservation period. IUC Feedbacks may be selected for further processing if condition from the specified list of alternatives is satisfied:
Alt. 1: Reservation period used feedback generation==reservation period of transmission.
Alt. 2: Reservation period used feedback generation is multiple of reservation period of transmission
Alt. 3: Reservation period transmission is multiple of reservation period used for feedback generation

Example 14 may include the method of examples 10, 11, or some other example herein, wherein IUC feedback filtering is based on information on resource selection window for feedback generation and resource selection window for transmission. IUC Feedbacks may be selected for further processing if condition from the specified list of alternatives is satisfied:
Alt. 1: RSW for feedback is within RSW for transmission
Alt. 2: RSW for transmission is within RSW for feedback.
Alt. 3: RSWs overlap on certain amount of slots

Example 15 may include the method of examples 10, 11, or some other example herein, wherein IUC feedback filtering is based on information on feedback generation timestamps. IUC Feedbacks may be selected for further processing if condition from the specified list of alternatives is satisfied:
Alt. 1: Current slot-Feedback timestamp (reference slot)<pre-configured or predefined value.
Alt. 2: Start (or end) slot of RSW for transmission-Feedback timestamp (reference slot)<pre-configured or predefined value.
Alt. 3: Slot associated with trigger for sidelink resource selection-Feedback timestamp (reference slot)<pre-configured value

Example 16 may include the method of examples 10, 11, or some other example herein, wherein IUC feedback filtering is based on information on IUC Feedback and TX UE sidelink transmission cast types and source/destinations.

Example 17 may include the method of example 16 or some other example herein, wherein non-preferred resources corresponding to Condition 1-B-2 are filtered out by TX-UE in case of (1) broadcast sidelink transmissions or (2) when UE-A is not target receiver

Example 18 may include the method of example 16 or some other example herein, wherein cast type and source of the IUC feedback is matched with cast type and destination of sidelink transmission.
The list of combinations of the cast types and source/destinations where information from IUC feedback may be used for resource selection is provided in section C.2 (Alt-1 for cast- and source/destination-based feedback filtering)

Example 19 may include the method of example 16 or some other example herein, wherein source of feedback is destination of sidelink transmission.
The list of combinations of the cast types and source/destinations where information from IUC feedback may be used for resource selection is provided in section C.2 (Alt-2 for cast- and source/destination-based feedback filtering)

Example 20 may include the method of example 16 or some other example herein, wherein destination of feedback is source of sidelink transmission.
The list of combinations of the cast types and source/destinations where information from IUC feedback may be used for resource selection is provided in section C.2 (Alt-3 for cast- and source/destination-based feedback filtering)

Example 21 may include the method of example 1 or some other example herein, wherein Transmit UE implements resource exclusion procedure which takes into account non-preferred resource set and uses at least one of the following conditions used to stop internal iterative resource exclusion:
Alternative 1 (Single threshold on size of candidate resource set for resource selection); For each RSRP threshold, the set of candidate resources remaining after non-preferred resource exclusion is compared with threshold M_{Thr}. Iteration over RSRP threshold stopped if the size of remaining candidate resource set exceeds threshold
Alternative 2 (Two thresholds on size of candidate resource sets): For each RSRP threshold, the set of candidate resources S_{Cand} is identified based on UE own sensing information. After that, the full set or subset of non-preferred resources S_{NP} is excluded from the identified candidate resource set S_{Cand} and the set of remain candidate resources S_{Cand_Remain} is obtained. The size of the remaining candidate resource set S_{Cand_Remain} is compared with preconfigured separate threshold M_{Thr_Remain} and the size of the candidate resource set S_{Cand} is compared with preconfigured threshold M_{Thr}. Iteration over RSRP threshold stops if the following conditions are simultaneously satisfied:
size (S_{Cand_Remain})_M_{Thr_Remain}
size (S_{Cand})≥M_{Thr}

Additional threshold M_{Thr_Remain} may be defined as a portion of total number of resources or as a portion of a maximum number of remaining resources.

Example 22 may include the method of example 21 or some other example herein, wherein only the full non-preferred resource set may be excluded during resource exclusion procedure.

Example 23 may include the method of example 22 or some other example herein, wherein.
If stop condition on the number of remaining resources cannot be satisfied for any RSRP threshold, resource exclusion procedure reports to higher layers the set of candidate resources S_{Cand} obtained based on UE own sensing information at the iteration over RSRP, where size (S_{Cand}) becomes equal or greater than M_{Thr}
Otherwise, minimum remaining candidate resource set which satisfies stop condition is reported.

Example 24 may include the method of example 22 or some other example herein, wherein resource exclusion procedure reports to higher layers the remaining set of candidate resources obtained at the last iteration over RSRP.

Example 25 may include the method of example 22 or some other example herein, wherein resource exclusion procedure reports to higher layers the full set of resources obtained after step 5a), e.g., all candidate resources (please refer to TS 38.214 section 8.1.4).

Example 26 may include the method of example 22 or some other example herein, wherein resource exclusion procedure reports to higher layers the remaining set of candidate resources wherein before resource exclusion procedure it is evaluated whether stop condition can be satisfied if non-preferred resource exclusion procedure is enabled and triggered. If it is decided that non-preferred resource exclusion procedure is enabled, the non-preferred resource set exclusion is triggered, otherwise resource selection procedure is executed without non-preferred resource set exclusion.

Example 27 may include the method of example 21 or some other example herein, wherein the part of input non-preferred resource set may be excluded during resource exclusion procedure.

Example 28 may include the method of example 27 or some other example herein, wherein restriction on the maximum size of the non-preferred resource set is applied.

Example 29 may include the method of example 28 or some other example herein, wherein the subset of non-preferred resources used for the exclusion is determined before the start of iterative resource selection and exclusion procedure.

Example 30 may include the method of example 29 or some other example herein, wherein the number of non-preferred resources which guarantees stop criteria may be estimated using the threshold value for the number of resources in remaining candidate resource set S_{Cand_Remain} and total number of resources in set SA obtained after step 5a) of the procedure in TS 38.214, section 8.1.4. Once the maximum number of non-preferred resources that may be processed is determined, the subset of non-preferred resources may also be determined. Afterward, the identified subset of non-preferred resources is used as a S_{NP} set for resource exclusion in step 6a).
The specified number of non-preferred resources may be taken randomly from the full set of non-preferred resources.

Example 31 may include the method of example 27 or some other example herein, wherein the subset of non-preferred resources excluded from the candidate resource set is determined at each iteration of the resource selection.

Example 32 may include the method of example 31 or some other example herein, wherein subset of non-preferred resources for used exclusion from identified candidate resource set is determined explicitly using the steps 1-3 as specified in Alternative 1 (Explicit determination of the subset of non-preferred resources for exclusion from identified candidate resource set) of the option 2 used for Solutions Type 2.

Example 33 may include the method of example 31 or some other example herein, wherein the subset of non-preferred resources for exclusion from identified candidate resource set is determined implicitly during the execution of the non-preferred resources exclusion.

Example 34 may include the method of example 33 or some other example herein, wherein the resources from non-preferred resource set are excluded from identified candidate resource set while the number of resources in remaining candidate resource set satisfies the used stop condition.

Example 35 may include the method of example 34 or some other example herein, wherein full non-preferred resource set is excluded from identified candidate resource set. If the number of resources in remaining candidate resource set is less than predefined threshold, the non-preferred resource set is reduced, and non-preferred resource set exclusion procedure is repeated until the size of the remaining candidate resource set exceeds threshold from the used stop condition.

Example 36 may include the method of example 31 or some other example herein, wherein threshold on minimum number of excluded non-preferred resources is introduced.

Example 37 may include the method of example 36 or some other example herein, wherein threshold on the minimum number of excluded non-preferred resources is implemented using one or more of the following design alternatives:
Alt. 1: Threshold is calculated as a ratio of the non-preferred resources to be excluded to total number of non-preferred resources.
Alt. 2: Absolute number of non-preferred resources to be excluded.

Example 38 may include a method to be performed by a user equipment (UE), one or elements of a UE, and/or an electronic device that includes and/or implements a UE, wherein the method comprises: identifying that the UE is to transmit a sidelink transmission; identifying whether the UE is to use a third generation partnership project (3GPP) release-17 resource selection procedure related to resources for the sidelink transmission or a 3GPP release-16 resource selection procedure related to resources for the sidelink transmission; identifying, based on the identified resource selection procedure, one or more resources for the sidelink transmission; and transmitting the sidelink transmission on the one or more resources.

Example 39 includes the method of example 38, and/or some other example herein, wherein identifying whether to use the 3GPP release-17 resource selection procedure or the 3GPP release-16 resource selection procedure is based on pre-configuration of the UE.

Example 40 includes the method of example 39, and/or some other example herein, wherein the pre-configuration of the UE includes pre-configuring the UE is to use the 3GPP release-17 resource selection procedure.

Example 41 includes the method of any of examples 38-40, and/or some other example herein, wherein the UE is a 3GPP release-17 UE.

Example 42 includes the method of any of examples 48-41, and/or some other example herein, wherein the 3GPP release-17 resource selection procedure includes consideration of inter-UE coordination (IUC) feedback.

Example 43 includes the method of example 42, and/or some other example herein, wherein the 3GPP release-16 resource selection procedure does not include consideration of inter-UE coordination (IUC) feedback.

Example 44 includes the method of any of examples 38-43, and/or some other example herein, wherein the sidelink transmission relates to inter-UE coordination (IUC) feedback.

Example 45 includes the method of any of examples 38-44, and/or some other example herein, wherein the sidelink transmission relates to sensing used for resource selection.

Example 46 includes a method to be performed by a user equipment (UE), one or more elements of a UE, and/or an electronic device that includes and/or implements a UE, wherein the method comprises: identifying a set of candidate resources related to transmission of a sidelink transmission; identifying, from the set of candidate resources, a subset of non-preferred resources; removing, from the set of candidate resources, resources in the subset of non-preferred resources to generate a subset of remaining candidate resources that is a subset of the set of candidate resources; and reporting, to higher layers, an indication of the subset of remaining candidate resources.

Example 47 includes the method of example 46, and/or some other example herein, wherein identifying the subset of non-preferred resources is based on a reference signal received power (RSRP) measurement of respective resources in the subset of non-preferred resources.

Example 48 includes the method of example 47, and/or some other example herein, wherein identifying the subset of non-preferred resources is based on the respective resources having a RSRP value that is lower than a threshold RSRP value.

Example 49 includes the method of any of examples 46-48, and/or some other example herein, wherein identifying the subset of non-preferred resources is based on identification that respective resources in the subset of non-preferred resources have been previously reserved by another UE.

Example 50 includes the method of any of examples 46-49, and/or some other example herein, further comprising transmitting the sidelink transmission using at least one resource of the subset of remaining candidate resources.

Example 51 includes the method of any of examples 46-50, and/or some other example herein, further comprising: identifying a number of resources in the set of candidate resources; comparing the number of resources in the set of candidate resources to a threshold value of a number of resources; and removing the resources in the subset of non-preferred resources based on the number of resources in the set of candidate resources being greater than the threshold value of the number of resources.

Example Z01 may include an apparatus comprising means to perform one or more elements of a method described in or related to any of examples 1-51, or any other method or process described herein.

Example Z02 may include one or more non-transitory computer-readable media comprising instructions to cause an electronic device, upon execution of the instructions by one or more processors of the electronic device, to perform one or more elements of a method described in or related to any of examples 1-51, or any other method or process described herein. Example Z03 may include an apparatus comprising logic, modules, or circuitry to perform one or more elements of a method described in or related to any of examples 1-51, or any other method or process described herein.

Example Z04 may include a method, technique, or process as described in or related to any of examples 1-51, or portions or parts thereof.

Example Z05 may include an apparatus comprising: one or more processors and one or more computer-readable media comprising instructions that, when executed by the one or more processors, cause the one or more processors to perform the method, techniques, or process as described in or related to any of examples 1-51, or portions thereof.

Example Z06 may include a signal as described in or related to any of examples 1-51, or portions or parts thereof.

Example Z07 may include a datagram, packet, frame, segment, protocol data unit (PDU), or message as described in or related to any of examples 1-51, or portions or parts thereof, or otherwise described in the present disclosure.

Example Z08 may include a signal encoded with data as described in or related to any of examples 1-51, or portions or parts thereof, or otherwise described in the present disclosure.

Example Z09 may include a signal encoded with a datagram, packet, frame, segment, protocol data unit (PDU), or message as described in or related to any of examples 1-51, or portions or parts thereof, or otherwise described in the present disclosure.

Example Z10 may include an electromagnetic signal carrying computer-readable instructions, wherein execution of the computer-readable instructions by one or more processors is to cause the one or more processors to perform the method, techniques, or process as described in or related to any of examples 1-51, or portions thereof.

Example Z11 may include a computer program comprising instructions, wherein execution of the program by a processing element is to cause the processing element to carry out the method, techniques, or process as described in or related to any of examples 1-51, or portions thereof.

Example Z12 may include a signal in a wireless network as shown and described herein. Example Z13 may include a method of communicating in a wireless network as shown and described herein.

Example Z14 may include a system for providing wireless communication as shown and described herein.

Example Z15 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

### Abbreviations

Unless used differently herein, terms, definitions, and abbreviations may be consistent with terms, definitions, and abbreviations defined in 3GPP TR 21.905 v16.0.0 (2019-06). For the purposes of the present document, the following abbreviations may apply to the examples and embodiments discussed herein.

| | |
|---|---|
| 3GPP | Third Generation Partnership Project |
| 4G | Fourth Generation |
| 5G | Fifth Generation |
| 5GC | 5G Core network |
| AC | Application Client |
| ACR | Application Context Relocation |
| ACK | Acknowledgement |
| ACID | Application Client Identification |
| AF | Application Function |
| AM | Acknowledged Mode |
| AMBR | Aggregate Maximum Bit Rate |
| AMF | Access and Mobility Management Function |
| AN | Access Network |
| ANR | Automatic Neighbour Relation |
| AOA | Angle of Arrival |
| AP | Application Protocol, Antenna Port, Access Point |
| API | Application Programming Interface |
| APN | Access Point Name |
| ARP | Allocation and Retention Priority |
| ARQ | Automatic Repeat Request |
| AS | Access Stratum |
| ASP | Application Service Provider |
| ASN.1 | Abstract Syntax Notation One |
| AUSF | Authentication Server Function |
| AWGN | Additive White Gaussian Noise |
| BAP | Backhaul Adaptation Protocol |
| BCH | Broadcast Channel |
| BER | Bit Error Ratio |
| BFD | Beam Failure Detection |
| BLER | Block Error Rate |
| BPSK | Binary Phase Shift Keying |
| BRAS | Broadband Remote Access Server |
| BSS | Business Support System |
| BS | Base Station |
| BSR | Buffer Status Report |
| BW | Bandwidth |
| BWP | Bandwidth Part |
| C-RNTI | Cell Radio Network Temporary Identity |
| CA | Carrier Aggregation, Certification Authority |
| CAPEX | CAPital EXpenditure |
| CBRA | Contention Based Random Access |
| CC | Component Carrier, Country Code, Cryptographic Checksum |
| CCA | Clear Channel Assessment |
| CCE | Control Channel Element |
| CCCH | Common Control Channel |
| CE | Coverage Enhancement |
| CDM | Content Delivery Network |
| CDMA | Code-Division Multiple Access |
| CDR | Charging Data Request |
| CDR | Charging Data Response |
| CFRA | Contention Free Random Access |
| CG | Cell Group |
| CGF | Charging Gateway Function |
| CHF | Charging Function |
| CI | Cell Identity |
| CID | Cell-ID (e.g., positioning method) |
| CIM | Common Information Model |
| CIR | Carrier to Interference Ratio |
| CK | Cipher Key |
| CM | Connection Management, Conditional Mandatory |
| CMAS | Commercial Mobile Alert Service |
| CMD | Command |
| CMS | Cloud Management System |
| CO | Conditional Optional |
| CoMP | Coordinated Multi-Point |
| CORESET | Control Resource Set |
| COTS | Commercial Off-The-Shelf |
| CP | Control Plane, Cyclic Prefix, Connection Point |
| CPD | Connection Point Descriptor |
| CPE | Customer Premise Equipment |
| CPICH | Common Pilot Channel |
| CQI | Channel Quality Indicator |
| CPU | CSI processing unit, Central Processing Unit |
| C/R | Command/Response field bit |
| CRAN | Cloud Radio Access Network, Cloud RAN |
| CRB | Common Resource Block |
| CRC | Cyclic Redundancy Check |
| CRI | Channel-State Information Resource Indicator, |
| | CSI-RS Resource Indicator |
| C-RNTI | Cell RNTI |
| CS | Circuit Switched |
| CSCF | call session control function |
| CSAR | Cloud Service Archive |
| CSI | Channel-State Information |
| CSI-IM | CSI Interference Measurement |
| CSI-RS | CSI Reference Signal |
| CSI-RSRP | CSI reference signal received power |
| CSI-RSRQ | CSI reference signal received quality |
| CSI-SINR | CSI signal-to-noise and interference ratio |
| CSMA | Carrier Sense Multiple Access |
| CSMA/CA | CSMA with collision avoidance |
| CSS | Common Search Space, Cell-specific Search Space |
| CTF | Charging Trigger Function |
| CTS | Clear-to-Send |
| CW | Codeword |
| CWS | Contention Window Size |
| D2D | Device-to-Device |
| DC | Dual Connectivity, Direct Current |
| DCI | Downlink Control Information |
| DF | Deployment Flavour |
| DL | Downlink |
| DMTF | Distributed Management Task Force |
| DPDK | Data Plane Development Kit |
| DM-RS, DMRS | Demodulation Reference Signal |
| DN | Data network |
| DNN | Data Network Name |
| DNAI | Data Network Access Identifier |
| DRB | Data Radio Bearer |
| DRS | Discovery Reference Signal |
| DRX | Discontinuous Reception |
| DSL | Domain Specific Language. Digital Subscriber Line |
| DSLAM | DSL Access Multiplexer |
| DwPTS | Downlink Pilot Time Slot |
| E-LAN | Ethernet Local Area Network |
| E2E | End-to-End |
| EAS | Edge Application Server |
| ECCA | extended clear channel assessment, extended CCA |
| ECCE | Enhanced Control Channel Element, Enhanced CCE |
| ED | Energy Detection |
| EDGE | Enhanced Datarates for GSM Evolution (GSM Evolution) |
| EAS | Edge Application Server |
| EASID | Edge Application Server Identification |
| ECS | Edge Configuration Server |
| ECSP | Edge Computing Service Provider |
| EDN | Edge Data Network |
| EEC | Edge Enabler Client |
| EECID | Edge Enabler Client Identification |
| EES | Edge Enabler Server |
| EESID | Edge Enabler Server Identification |
| EHE | Edge Hosting Environment |
| EGMF | Exposure Governance Management Function |
| EGPRS | Enhanced GPRS |
| EIR | Equipment Identity Register |
| eLAA | enhanced Licensed Assisted Access, enhanced LAA |
| EM | Element Manager |
| eMBB | Enhanced Mobile Broadband |
| EMS | Element Management System |
| eNB | evolved NodeB, E-UTRAN Node B |
| EN-DC | E-UTRA-NR Dual Connectivity |
| EPC | Evolved Packet Core |
| EPDCCH | enhanced PDCCH, enhanced Physical Downlink Control Cannel |
| EPRE | Energy per resource element |
| EPS | Evolved Packet System |
| EREG | enhanced REG, enhanced resource element groups |
| ETSI | European Telecommunications Standards Institute |
| ETWS | Earthquake and Tsunami Warning System |
| eUICC | embedded UICC, embedded Universal Integrated Circuit Card |
| E-UTRA | Evolved UTRA |
| E-UTRAN | Evolved UTRAN |
| EV2X | Enhanced V2X |
| F1AP | F1 Application Protocol |
| F1-C | F1 Control plane interface |
| F1-U | F1 User plane interface |
| FACCH | Fast Associated Control CHannel |
| FACCH/F | Fast Associated Control Channel/Full rate |
| FACCH/H | Fast Associated Control Channel/Half rate |
| FACH | Forward Access Channel |
| FAUSCH | Fast Uplink Signalling Channel |
| FB | Functional Block |
| FBI | Feedback Information |
| FCC | Federal Communications Commission |
| FCCH | Frequency Correction CHannel |
| FDD | Frequency Division Duplex |
| FDM | Frequency Division Multiplex |
| FDMA | Frequency Division Multiple Access |
| FE | Front End |
| FEC | Forward Error Correction |
| FFS | For Further Study |
| FFT | Fast Fourier Transformation |
| feLAA | further enhanced Licensed Assisted Access, |
| | further enhanced LAA |
| FN | Frame Number |
| FPGA | Field-Programmable Gate Array |
| FR | Frequency Range |
| FQDN | Fully Qualified Domain Name |
| G-RNTI | GERAN Radio Network Temporary Identity |
| GERAN GSM EDGE RAN, | GSM EDGE Radio Access Network |
| GGSN | Gateway GPRS Support Node |
| GLONASS | GLObal'naya NAvigatsionnay a Sputnikovaya |
| | Sistema (Engl.: Global Navigation Satellite System) |
| gNB | Next Generation NodeB |
| gNB-CU | gNB-centralized unit, Next Generation NodeB centralized unit |
| gNB-DU | gNB-distributed unit, Next Generation NodeB distributed unit |
| GNSS | Global Navigation Satellite System |
| GPRS | General Packet Radio Service |
| GPSI | Generic Public Subscription Identifier |
| GSM | Global System for Mobile Communications, |
| | Groupe Spécial Mobile |
| GTP GPRS | Tunneling Protocol |
| GTP-UGPRS | Tunnelling Protocol for User Plane |
| GTS | Go To Sleep Signal (related to WUS) |
| GUMMEI | Globally Unique MME Identifier |
| GUTI | Globally Unique Temporary UE Identity |
| HARQ | Hybrid ARQ, Hybrid Automatic Repeat Request |
| HANDO | Handover |
| HFN | HyperFrame Number |
| HHO | Hard Handover |
| HLR | Home Location Register |
| HN | Home Network |
| HO | Handover |
| HPLMN | Home Public Land Mobile Network |
| HSDPA | High Speed Downlink Packet Access |
| HSN | Hopping Sequence Number |
| HSPA | High Speed Packet Access |
| HSS | Home Subscriber Server |
| HSUPA | High Speed Uplink Packet Access |
| HTTP | Hyper Text Transfer Protocol |
| HTTPS | Hyper Text Transfer Protocol Secure |
| | (https is http/1.1 over SSL, i.e. port 443) |
| I-Block | Information Block |
| ICCID | Integrated Circuit Card Identification |
| IAB | Integrated Access and Backhaul |
| ICIC | Inter-Cell Interference Coordination |
| ID | Identity, identifier |
| IDFT | Inverse Discrete Fourier Transform |
| IE | Information element |
| IBE | In-Band Emission |
| IEEE | Institute of Electrical and Electronics Engineers |
| IEI | Information Element Identifier |
| IEIDL | Information Element Identifier Data Length |
| IETF | Internet Engineering Task Force |
| IF | Infrastructure |
| IIOT | Industrial Internet of Things |
| IM | Interference Measurement, Intermodulation, |
| | IP Multimedia |
| IMC | IMS Credentials |
| IMEI | International Mobile Equipment Identity |
| IMGI | International mobile group identity |
| IMPI | IP Multimedia Private Identity |
| IMPU | IP Multimedia PUblic identity |
| IMS | IP Multimedia Subsystem |
| IMSI | International Mobile Subscriber Identity |
| IoT | Internet of Things |
| IP | Internet Protocol Ipsec IP Security, |
| | Internet Protocol Security |
| IP-CAN | IP-Connectivity Access Network |
| IP-M | IP Multicast |
| IPv4 | Internet Protocol Version 4 |
| IPv6 | Internet Protocol Version 6 |
| IR | Infrared |
| IS | In Sync |
| IRP | Integration Reference Point |
| ISDN | Integrated Services Digital Network |
| ISIM | IM Services Identity Module |
| ISO | International Organisation for Standardisation |
| ISP | Internet Service Provider |
| IWF | Interworking-Function |
| I-WLAN | Interworking WLAN Constraint length of the |
| | convolutional code, USIM Individual key |
| kB | Kilobyte (1000 bytes) |
| kbps | kilo-bits per second |
| Kc | Ciphering key |
| Ki | Individual subscriber authentication key |
| KPI | Key Performance Indicator |
| KQI | Key Quality Indicator |
| KSI | Key Set Identifier |
| ksps | kilo-symbols per second |
| KVM | Kernel Virtual Machine |
| L1 | Layer 1 (physical layer) |
| L1-RSRP | Layer 1 reference signal received power |
| L2 | Layer 2 (data link layer) |
| L3 | Layer 3 (network layer) |
| LAA | Licensed Assisted Access |
| LAN | Local Area Network |
| LADN | Local Area Data Network |
| LBT | Listen Before Talk |
| LCM | LifeCycle Management |
| LCR | Low Chip Rate |
| LCS | Location Services |
| LCID | Logical Channel ID |
| LI | Layer Indicator |
| LLC | Logical Link Control, Low Layer Compatibility |
| LMF | Location Management Function |
| LOS | Line of Sight |
| LPLMN | Local PLMN |
| LPP | LTE Positioning Protocol |
| LSB | Least Significant Bit |
| LTE | Long Term Evolution |
| LWA | LTE-WLAN aggregation |
| LWIP | LTE/WLAN Radio Level Integration with IPsec Tunnel |
| LTE | Long Term Evolution |
| M2M | Machine-to-Machine |
| MAC | Medium Access Control (protocol layering context) |
| MAC | Message authentication code (security/encryption context) |
| MAC-A | MAC used for authentication and key agreement (TSG T WG3 context) |
| MAC-IMAC | used for data integrity of signalling messages (TSG T WG3 context) |
| MANO | Management and Orchestration |
| MBMS | Multimedia Broadcast and Multicast Service |
| MBSFN | Multimedia Broadcast multicast service Single Frequency Network |
| MCC | Mobile Country Code |
| MCG | Master Cell Group |
| MCOT | Maximum Channel Occupancy Time |
| MCS | Modulation and coding scheme |
| MDAF | Management Data Analytics Function |
| MDAS | Management Data Analytics Service |
| MDT | Minimization of Drive Tests |
| ME | Mobile Equipment |
| MeNB | master eNB |
| MER | Message Error Ratio |
| MGL | Measurement Gap Length |
| MGRP | Measurement Gap Repetition Period |
| MIB | Master Information Block, Management Information Base |
| MIMO | Multiple Input Multiple Output |
| MLC | Mobile Location Centre |
| MM | Mobility Management |
| MME | Mobility Management Entity |
| MN | Master Node |
| MNO | Mobile Network Operator |
| MO | Measurement Object, Mobile Originated |
| MPBCH | MTC Physical Broadcast CHannel |
| MPDCCH | MTC Physical Downlink Control CHannel |
| MPDSCH | MTC Physical Downlink Shared CHannel |
| MPRACH | MTC Physical Random Access CHannel |
| MPUSCH | MTC Physical Uplink Shared Channel |
| MPLS | MultiProtocol Label Switching |
| MS | Mobile Station |
| MSB | Most Significant Bit |
| MSC | Mobile Switching Centre |
| MSI | Minimum System Information, |
| MCH | Scheduling Information |
| MSID | Mobile Station Identifier |
| MSIN | Mobile Station Identification Number |
| MSISDN | Mobile Subscriber ISDN Number |
| MT | Mobile Terminated, Mobile Termination |
| MTC | Machine-Type Communications |
| | mMTCmassive MTC, massive Machine-Type Communications |
| MU-MIMO | Multi User MIMO |
| MWUS | MTC wake-up signal, MTC WUS |
| NACK | Negative Acknowledgement |
| NAI | Network Access Identifier |
| NAS | Non-Access Stratum, Non- Access Stratum layer |
| NCT | Network Connectivity Topology |
| NC-JT | Non-Coherent Joint Transmission |
| NEC | Network Capability Exposure |
| NE-DC | NR-E-UTRA Dual Connectivity |
| NEF | Network Exposure Function |
| NF | Network Function |
| NFP | Network Forwarding Path |
| NFPD | Network Forwarding Path Descriptor |
| NFV | Network Functions Virtualization |
| NFVI | NFV Infrastructure |
| NFVO | NFV Orchestrator |
| NG | Next Generation, Next Gen |
| NGEN-DC | NG-RAN E-UTRA-NR Dual Connectivity |
| NM | Network Manager |
| NMS | Network Management System |
| N-PoP | Network Point of Presence |
| NMIB, | N-MIB Narrowband MIB |
| NPBCH | Narrowband Physical Broadcast CHannel |
| NPDCCH | Narrowband Physical Downlink Control CHannel |
| NPDSCH | Narrowband Physical Downlink Shared CHannel |
| NPRACH | Narrowband Physical Random Access CHannel |
| NPUSCH | Narrowband Physical Uplink Shared CHannel |
| NPSS | Narrowband Primary Synchronization Signal |
| NSSS | Narrowband Secondary Synchronization Signal |
| NR | New Radio, Neighbour Relation |
| NRF | NF Repository Function |
| NRS | Narrowband Reference Signal |
| NS | Network Service |
| NSA | Non-Standalone operation mode |
| NSD | Network Service Descriptor |
| NSR | Network Service Record |
| NSSAI | Network Slice Selection Assistance Information |
| S-NNSAI | Single-NSSAI |
| NSSF | Network Slice Selection Function |
| NW | Network |
| NWUS | Narrowband wake-up signal, Narrowband WUS |
| NZP | Non-Zero Power |
| O&M | Operation and Maintenance |
| ODU2 | Optical channel Data Unit - type 2 |
| OFDM | Orthogonal Frequency Division Multiplexing |
| OFDMA | Orthogonal Frequency Division Multiple Access |
| OOB | Out-of-Band |
| OOS | Out of Sync |
| OPEX | OPerating EXpense |
| OSI | Other System Information |
| OSS | Operations Support System |
| OTA | over-the-air |
| PAPR | Peak-to-Average Power Ratio |
| PAR | Peak to Average Ratio |
| PBCH | Physical Broadcast Channel |
| PC | Power Control, Personal Computer |
| PCC | Primary Component Carrier, Primary CC |
| P-CSCF | Proxy CSCF |
| PCell | Primary Cell |
| PCI | Physical Cell ID, Physical Cell Identity |
| PCEF | Policy and Charging Enforcement Function |
| PCF | Policy Control Function |
| PCRF | Policy Control and Charging Rules Function |
| PDCP | Packet Data Convergence Protocol, |
| | Packet Data Convergence Protocol layer |
| PDCCH | Physical Downlink Control Channel |
| PDCP | Packet Data Convergence Protocol |
| PDN | Packet Data Network, Public Data Network |
| PDSCH | Physical Downlink Shared Channel |
| PDU | Protocol Data Unit |
| PEI | Permanent Equipment Identifiers |
| PFD | Packet Flow Description |
| P-GW | PDN Gateway |
| PHICH | Physical hybrid-ARQ indicator channel |
| PHY | Physical layer |
| PLMN | Public Land Mobile Network |
| PIN | Personal Identification Number |
| PM | Performance Measurement |
| PMI | Precoding Matrix Indicator |
| PNF | Physical Network Function |
| PNFD | Physical Network Function Descriptor |
| PNFR | Physical Network Function Record |
| POC | PTT over Cellular |
| PP, PTP | Point-to-Point |
| PPP | Point-to-Point Protocol |
| PRACH | Physical RACH |
| PRB | Physical resource block |
| PRG | Physical resource block group |
| ProSe | Proximity Services, Proximity-Based Service |
| PRS | Positioning Reference Signal |
| PRR | Packet Reception Radio |
| PS | Packet Services |
| PSBCH | Physical Sidelink Broadcast Channel |
| PSDCH | Physical Sidelink Downlink Channel |
| PSCCH | Physical Sidelink Control Channel |
| PSSCH | Physical Sidelink Shared Channel |
| PSCell | Primary SCell |
| PSS | Primary Synchronization Signal |
| PSTN | Public Switched Telephone Network |
| PT-RS | Phase-tracking reference signal |
| PTT | Push-to-Talk |
| PUCCH | Physical Uplink Control Channel |
| PUSCH | Physical Uplink Shared Channel |
| QAM | Quadrature Amplitude Modulation |
| QCI | QoS class of identifier |
| QCL | Quasi co-location |
| QFI | QoS Flow ID, QoS Flow Identifier |
| QoS | Quality of Service |
| QPSK | Quadrature (Quarternary) Phase Shift Keying |
| QZSS | Quasi-Zenith Satellite System |
| RA-RNTI | Random Access RNTI |
| RAB | Radio Access Bearer, Random Access Burst |
| RACH | Random Access Channel |
| RADIUS | Remote Authentication Dial In User Service |
| RAN | Radio Access Network |
| RAND | RANDom number (used for authentication) |
| RAR | Random Access Response |
| RAT | Radio Access Technology |
| RAU | Routing Area Update |
| RB | Resource block, Radio Bearer |
| RBG | Resource block group |
| REG | Resource Element Group |
| Rel | Release |
| REQ | REQuest |
| RF | Radio Frequency |
| RI | Rank Indicator |
| RIV | Resource indicator value |
| RL | Radio Link |
| RLC | Radio Link Control, Radio Link Control layer |
| RLC AM | RLC Acknowledged Mode |
| RLC UM | RLC Unacknowledged Mode |
| RLF | Radio Link Failure |
| RLM | Radio Link Monitoring |
| RLM-RS | Reference Signal for RLM |
| RM | Registration Management |
| RMC | Reference Measurement Channel |
| RMSI | Remaining MSI, Remaining Minimum System Information |
| RN | Relay Node |
| RNC | Radio Network Controller |
| RNL | Radio Network Layer |
| RNTI | Radio Network Temporary Identifier |
| ROHC | RObust Header Compression |
| RRC | Radio Resource Control, Radio Resource Control layer |
| RRM | Radio Resource Management |
| RS | Reference Signal |
| RSRP | Reference Signal Received Power |
| RSRQ | Reference Signal Received Quality |
| RSSI | Received Signal Strength Indicator |
| RSU | Road Side Unit |
| RSTD | Reference Signal Time difference |
| RTP | Real Time Protocol |
| RTS | Ready-To-Send |
| RTT | Round Trip Time |
| Rx | Reception, Receiving, Receiver |
| S1AP | S1 Application Protocol |
| S1-MME | S1 for the control plane |
| S1-U | S1 for the user plane |
| S-CSCF | serving CSCF |
| S-GW | Serving Gateway |
| S-RNTI | SRNC Radio Network Temporary Identity |
| S-TMSI | SAE Temporary Mobile Station Identifier |
| SA | Standalone operation mode |
| SAE | System Architecture Evolution |
| SAP | Service Access Point |
| SAPD | Service Access Point Descriptor |
| SAPI | Service Access Point Identifier |
| SCC | Secondary Component Carrier, Secondary CC |
| SCell | Secondary Cell |
| SCEF | Service Capability Exposure Function |
| SC-FDMA | Single Carrier Frequency Division Multiple Access |
| SCG | Secondary Cell Group |
| SCM | Security Context Management |
| SCS | Subcarrier Spacing |
| SCTP | Stream Control Transmission Protocol |
| SDAP | Service Data Adaptation Protocol, |
| | Service Data Adaptation Protocol layer |
| SDL | Supplementary Downlink |
| SDNF | Structured Data Storage Network Function |
| SDP | Session Description Protocol |
| SDSF | Structured Data Storage Function |
| SDT | Small Data Transmission |
| SDU | Service Data Unit |
| SEAF | Security Anchor Function |
| SeNB | secondary eNB |
| SEPP | Security Edge Protection Proxy |
| SFI | Slot format indication |
| SFTD | Space-Frequency Time Diversity, SFN and frame timing difference |
| SFN | System Frame Number |
| SgNB | Secondary gNB |
| SGSN | Serving GPRS Support Node |
| S-GW | Serving Gateway |
| SI | System Information |
| SI-RNTI | System Information RNTI |
| SIB | System Information Block |
| SIM | Subscriber Identity Module |
| SIP | Session Initiated Protocol |
| SiP | System in Package |
| SL | Sidelink |
| SLA | Service Level Agreement |
| SM | Session Management |
| SMF | Session Management Function |
| SMS | Short Message Service |
| SMSF | SMS Function |
| SMTC | SSB-based Measurement Timing Configuration |
| SN | Secondary Node, Sequence Number |
| SoC | System on Chip |
| SON | Self-Organizing Network |
| SpCell | Special Cell |
| SP-CSI-RNTI | Semi-Persistent CSI RNTI |
| SPS | Semi-Persistent Scheduling |
| SQN | Sequence number |
| SR | Scheduling Request |
| SRB | Signalling Radio Bearer |
| SRS | Sounding Reference Signal |
| SS | Synchronization Signal |
| SSB | Synchronization Signal Block |
| SSID | Service Set Identifier |
| SS/PBCH | Block SSBRI SS/PBCH Block Resource Indicator, |
| | Synchronization Signal Block Resource Indicator |
| SSC | Session and Service Continuity |
| SS-RSRP | Synchronization Signal based Reference Signal |
| | Received Power |
| SS-RSRQ | Synchronization Signal based Reference Signal |
| | Received Quality |
| SS-SINR | Synchronization Signal based Signal to Noise |
| | and Interference Ratio |
| SSS | Secondary Synchronization Signal |
| SSSG | Search Space Set Group |
| SSSIF | Search Space Set Indicator |
| SST | Slice/Service Types |
| SU-MIMO | Single User MIMO |
| SUL | Supplementary Uplink |
| TA | Timing Advance, Tracking Area |
| TAC | Tracking Area Code |
| TAG | Timing Advance Group |
| TAI | Tracking Area Identity |
| TAU | Tracking Area Update |
| TB | Transport Block |
| TBS | Transport Block Size |
| TBD | To Be Defined |
| TCI | Transmission Configuration Indicator |
| TCP | Transmission Communication Protocol |
| TDD | Time Division Duplex |
| TDM | Time Division Multiplexing |
| TDMA | Time Division Multiple Access |
| TE | Terminal Equipment |
| TEID | Tunnel End Point Identifier |
| TFT | Traffic Flow Template |
| TMSI | Temporary Mobile Subscriber Identity |
| TNL | Transport Network Layer |
| TPC | Transmit Power Control |
| TPMI | Transmitted Precoding Matrix Indicator |
| TR | Technical Report |
| TRP, TRxP | Transmission Reception Point |
| TRS | Tracking Reference Signal |
| TRx | Transceiver |
| TS | Technical Specifications, Technical Standard |
| TTI | Transmission Time Interval |
| Tx | Transmission, Transmitting, Transmitter |
| U-RNTI | UTRAN Radio Network Temporary Identity |
| UART | Universal Asynchronous Receiver and Transmitter |
| UCI | Uplink Control Information |
| UE | User Equipment |
| UDM | Unified Data Management |
| UDP | User Datagram Protocol |
| USDF | Unstructured Data Storage Network Function |
| UICC | Universal Integrated Circuit Card |
| UL | Uplink |
| UM | Unacknowledged Mode |
| UML | Unified Modelling Language |
| UMTS | Universal Mobile Telecommunications System |
| UP | User Plane |
| UPF | User Plane Function |
| URI | Uniform Resource Identifier |
| URL | Uniform Resource Locator |
| URLLC | Ultra-Reliable and Low Latency |
| USB | Universal Serial Bus |
| USIM | Universal Subscriber Identity Module |
| USS | UE-Specific search space |
| UTRA | UMTS Terrestrial Radio Access |
| UTRAN | Universal Terrestrial Radio Access Network |
| UwPTS | Uplink Pilot Time Slot |
| V2I | Vehicle-to-Infrastruction |
| V2P | Vehicle-to-Pedestrian |
| V2V | Vehicle-to-Vehicle |
| V2X | Vehicle-to-everything |
| VIM | Virtualized Infrastructure Manager |
| VL | Virtual Link, |
| VLAN | Virtual LAN, Virtual Local Area Network |
| VM | Virtual Machine |
| VNF | Virtualized Network Function |
| VNFFG | VNF Forwarding Graph |
| VNFFGD | VNF Forwarding Graph Descriptor |
| VNFM | VNF Manager |
| VoIP | Voice-over-IP, Voice-over- Internet Protocol |
| VPLMN | Visited Public Land Mobile Network |
| VPN | Virtual Private Network |
| VRB | Virtual Resource Block |
| WiMAX | Worldwide Interoperability for Microwave Access |
| WLAN | Wireless Local Area Network |
| WMAN | Wireless Metropolitan Area Network |
| WPAN | Wireless Personal Area Network |
| X2-C | X2-Control plane |
| X2-U | X2-User plane |
| XML | eXtensible Markup Language |
| XRES | EXpected user REsponse |
| XOR | eXclusive OR |
| ZC | Zadoff-Chu |
| ZP | Zero Power |

### Terminology

For the purposes of the present document, the following terms and definitions are applicable to the examples and embodiments discussed herein.

The term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, and/or transferring digital data. Processing circuitry may include one or more processing cores to execute instructions and one or more memory structures to store program and data information. The term “processor circuitry” may refer to one or more application processors, one or more baseband processors, a physical central processing unit (CPU), a single-core processor, a dual-core processor, a triple-core processor, a quad-core processor, and/or any other device capable of executing or otherwise operating computer-executable instructions, such as program code, software modules, and/or functional processes. Processing circuitry may include more hardware accelerators, which may be microprocessors, programmable processing devices, or the like. The one or more hardware accelerators may include, for example, computer vision (CV) and/or deep learning (DL) accelerators. The terms “application circuitry” and/or “baseband circuitry” may be considered synonymous to, and may be referred to as, “processor circuitry.”

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, and/or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “network element” as used herein refers to physical or virtualized equipment and/or infrastructure used to provide wired or wireless communication network services. The term “network element” may be considered synonymous to and/or referred to as a networked computer, networking hardware, network equipment, network node, router, switch, hub, bridge, radio network controller, RAN device, RAN node, gateway, server, virtualized VNF, NFVI, and/or the like.

The term “computer system” as used herein refers to any type interconnected electronic devices, computer devices, or components thereof. Additionally, the term “computer system” and/or “system” may refer to various components of a computer that are communicatively coupled with one another. Furthermore, the term “computer system” and/or “system” may refer to multiple computer devices and/or multiple computing systems that are communicatively coupled with one another and configured to share computing and/or networking resources.

The term “appliance,” “computer appliance,” or the like, as used herein refers to a computer device or computer system with program code (e.g., software or firmware) that is specifically designed to provide a specific computing resource. A “virtual appliance” is a virtual machine image to be implemented by a hypervisor-equipped device that virtualizes or emulates a computer appliance or otherwise is dedicated to provide a specific computing resource.

The term “resource” as used herein refers to a physical or virtual device, a physical or virtual component within a computing environment, and/or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, and/or the like. A “hardware resource” may refer to compute, storage, and/or network resources provided by physical hardware element(s). A “virtualized resource” may refer to compute, storage, and/or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing and/or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” as used herein refers to a connection between two devices through a RAT for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or link, and/or the like.

The term “information element” refers to a structural element containing one or more fields. The term “field” refers to individual contents of an information element, or a data element that contains content.

The term “SMTC” refers to an SSB-based measurement timing configuration configured by SSB-MeasurementTimingConfiguration.

The term “SSB” refers to an SS/PBCH block.

The term “a “Primary Cell” refers to the MCG cell, operating on the primary frequency, in which the UE either performs the initial connection establishment procedure or initiates the connection re-establishment procedure.

The term “Primary SCG Cell” refers to the SCG cell in which the UE performs random access when performing the Reconfiguration with Sync procedure for DC operation.

The term “Secondary Cell” refers to a cell providing additional radio resources on top of a Special Cell for a UE configured with CA.

The term “Secondary Cell Group” refers to the subset of serving cells comprising the PSCell and zero or more secondary cells for a UE configured with DC.

The term “Serving Cell” refers to the primary cell for a UE in RRC_CONNECTED not configured with CA/DC there is only one serving cell comprising of the primary cell.

The term “serving cell” or “serving cells” refers to the set of cells comprising the Special Cell(s) and all secondary cells for a UE in RRC_CONNECTED configured with CA/.

The term “Special Cell” refers to the PCell of the MCG or the PSCell of the SCG for DC operation; otherwise, the term “Special Cell” refers to the Pcell.

The invention claimed is:

1.-20. (canceled)

21. An apparatus to be used in a user equipment (UE), wherein the apparatus comprises:
one or more processors; and
one or more non-transitory computer-readable media (NTCRM) comprising instructions that, upon execution of the instructions by the one or more processors, are to cause the UE to:
identify that the UE is to transmit a sidelink transmission;
identify whether the UE is to use a third generation partnership project (3GPP) release-17 resource selection procedure related to resources for the sidelink transmission or a 3GPP release-16 resource selection procedure related to resources for the sidelink transmission;
identify, based on the identified resource selection procedure, one or more resources for the sidelink transmission; and
transmit the sidelink transmission on the one or more resources.

22. The apparatus of claim 21, wherein the identification of whether to use the 3GPP release-17 resource selection procedure or the 3GPP release-16 resource selection procedure is based on pre-configuration of the UE.

23. The apparatus of claim 22, wherein the pre-configuration of the UE includes pre-configuring the UE is to use the 3GPP release-17 resource selection procedure.

24. The apparatus of claim 21, wherein the UE is a 3GPP release-17 UE.

25. The apparatus of claim 21, wherein the 3GPP release-17 resource selection procedure includes consideration of inter-UE coordination (IUC) feedback.

26. The apparatus of claim 25, wherein the 3GPP release-16 resource selection procedure does not include consideration of inter-UE coordination (IUC) feedback.

27. The apparatus of claim 21, wherein the sidelink transmission relates to inter-UE coordination (IUC) feedback.

28. The apparatus of claim 21, wherein the sidelink transmission relates to sensing used for resource selection.

29. An apparatus for use in a user equipment (UE), wherein the apparatus comprises:
one or more processors; and
one or more non-transitory computer-readable media (NTCRM) comprising instructions that, upon execution of the instructions by the one or more processors, are to cause the UE to:
identify a set of candidate resources related to transmission of a sidelink transmission;
identify, from the set of candidate resources, a subset of non-preferred resources;
remove, from the set of candidate resources, resources in the subset of non-preferred resources to generate a subset of remaining candidate resources that is a subset of the set of candidate resources; and
report, to higher layers, an indication of the subset of remaining candidate resources.

30. The apparatus of claim 29, wherein the instructions are to identify the subset of non-preferred resources based on a reference signal received power (RSRP) measurement of respective resources in the subset of non-preferred resources.

31. The apparatus of claim 30, wherein the instructions are to identify the subset of non-preferred resources based on the respective resources having a RSRP value that is lower than a threshold RSRP value.

32. The apparatus of claim 29, wherein the instructions are to identify the subset of non-preferred resources based on identification that respective resources in the subset of non-preferred resources have been previously reserved by another UE.

33. The apparatus of claim 29, wherein the instructions are further to transmit the sidelink transmission using at least one resource of the subset of remaining candidate resources.

34. The apparatus of claim 29, wherein the instructions are further to:
identify a number of resources in the set of candidate resources;
compare the number of resources in the set of candidate resources to a threshold value of a number of resources; and
remove the resources in the subset of non-preferred resources based on the number of resources in the set of candidate resources being greater than the threshold value of the number of resources.

35. One or more non-transitory computer-readable media (NTCRM) comprising instructions that, upon execution of the instructions by one or more processors, are to cause a user equipment (UE) to:
identify a set of candidate resources related to transmission of a sidelink transmission;
identify, from the set of candidate resources, a subset of non-preferred resources;
remove, from the set of candidate resources, resources in the subset of non-preferred resources to generate a subset of remaining candidate resources that is a subset of the set of candidate resources; and
report, to higher layers, an indication of the subset of remaining candidate resources.

36. The one or more NTCRM of claim 35, wherein the instructions are to identify the subset of non-preferred resources based on a reference signal received power (RSRP) measurement of respective resources in the subset of non-preferred resources.

37. The one or more NTCRM of claim 36, wherein the instructions are to identify the subset of non-preferred resources based on the respective resources having a RSRP value that is lower than a threshold RSRP value.

38. The one or more NTCRM of claim 35, wherein the instructions are to identify the subset of non-preferred resources based on identification that respective resources in the subset of non-preferred resources have been previously reserved by another UE.

39. The one or more NTCRM of claim 35, wherein the instructions are further to transmit the sidelink transmission using at least one resource of the subset of remaining candidate resources.

40. The one or more NTCRM of claim 35, wherein the instructions are further to:
identify a number of resources in the set of candidate resources;
compare the number of resources in the set of candidate resources to a threshold value of a number of resources; and
remove the resources in the subset of non-preferred resources based on the number of resources in the set of candidate resources being greater than the threshold value of the number of resources.
